(19) United States
(12) Patent Application Publication
(10) Pub. No.: US 2023/0262700 A1
(43) Pub. Date: Aug. 17, 2023

(54) ELECTRONIC DEVICE, WIRELESS COMMUNICATION METHOD, AND COMPUTER READABLE STORAGE MEDIUM

(71) Applicant: Sony Group Corporation, Tokyo (JP)

(72) Inventors: Min LIU, Beijing (CN); Jianfei CAO, Beijing (CN); Chen SUN, Beijing (CN)

(73) Assignee: Sony Group Corporation, Tokyo (JP)

(21) Appl. No.: 18/014,505

(22) PCT Filed: Jul. 29, 2021
(86) PCT No.: PCT/CN2021/109110

§ 371 Date: Jan. 5, 2023

(30) Foreign Application Priority Data
Aug. 5, 2020 (CN) 202010776963.6

(51) Int. Cl. H04W 72/1273; H04W 72/232

(52) U.S. Cl. CPC H04W 72/1273; H04W 72/232; H04W 88/04

(57) ABSTRACT

The present disclosure relates to an electronic device, a wireless communication method, and a computer-readable storage medium. The electronic device according to the present disclosure comprises a processing circuit that is configured to: generate downlink control information (DCI), which comprises scheduling information of a first channel used by the electronic device to transmit data to a relay user equipment (UE) and scheduling information of a second channel used by the relay UE to forward the data to a remote UE, the size of the DCI being the same as that of a DCI format for downlink scheduling or a DCI format for direct link scheduling; and transmit the generated DCI to the relay UE. By using the electronic device, wireless communication method, and computer-readable storage medium according to the present disclosure, a resource scheduling process in a data transmission process using relay technology can be simplified, thereby reducing delay.

This application claims the priority to Chinese Patent Application No. 202010776963.6 titled “ELECTRONIC DEVICE, WIRELESS COMMUNICATION METHOD, AND COMPUTER READABLE STORAGE MEDIUM”, filed on Aug. 5, 2020 with the China National Intellectual Property Administration (CNIPA), which is incorporated herein by reference in its entirety.

### FIELD

Embodiments of the present disclosure generally relate to the field of wireless communications, and in particular to an electronic device, a wireless communication method, and a computer readable storage medium. More particularly, the present disclosure relates to an electronic device as a network side device in a wireless communication system, an electronic device as user equipment in a wireless communication system, a wireless communication method executed by a network side device in a wireless communication system, a wireless communication method executed by user equipment in a wireless communication system and a computer readable storage medium.

### BACKGROUND

In a case that a coverage of a base station device is insufficient or a strength of a signal of the base station device is not strong, the relay technology may be adopted, that is, a relay device may be used to assist the communication between user equipment and a base station device, thereby expanding the coverage of the base station device. In the relay technology, user equipment may be implemented as relay equipment. Generally, user equipment for forwarding information may be referred to as relay user equipment, while user equipment that cannot directly communicate with the base station device may be referred to as remote user equipment. That is, in downlink transmission, relay user equipment may forward information from a base station device to remote user equipment, and in uplink transmission, relay user equipment may forward information from remote user equipment to a base station device. In addition, there may be situations where relay user equipment is needed in uplink transmission but not in downlink transmission, or relay user equipment is needed in downlink transmission but not in uplink transmission, or relay user equipment is needed in both uplink transmission and downlink transmission.

A link between user equipment may be referred to as a SideLink (SL). For resource allocation methods of the sidelink, in Mode 1 method, resources used by user equipment as a transmitting end to transmit information are determined by a base station device. As described above, in the wireless communication system using relay technology the link between the remote user equipment and the base station device is divided into two parts, namely, a link between remote user equipment and relay user equipment and a link between relay user equipment and base station device. In this way, the base station device is required to indicate resource scheduling information on the two parts respectively, which makes the process of data transmission more complicated and increases the delay of data transmission.

Therefore, it is necessary to propose a technical scheme to simplify the resource scheduling process in the data transmission procedure using relay technology, thereby reducing the delay.

### SUMMARY

This summary section provides a general summary of the present disclosure, rather than a comprehensive disclosure of full scope or full features of the present disclosure.

An object of the present disclosure is to provide an electronic device, a wireless communication method and a computer readable storage medium, to simplify the resource scheduling process in the data transmission procedure using relay technology, thereby reducing the delay.

According to an aspect of the present disclosure, an electronic device is provided. The electronic device includes processing circuitry configured to: generate downlink control information (DCI) which includes scheduling information of a first channel for the electronic device to transmit data to relay user equipment and scheduling information of a second channel for the relay user equipment to forward the data to remote user equipment, and a size of which is the same as that of a DCI format for downlink scheduling or that of a DCI format for sidelink scheduling; and transmit the generated DCI to the relay user equipment.

According to another aspect of the present disclosure, an electronic device is provided. The electronic device includes processing circuitry configured to: receive downlink control information (DCI), a size of which is the same as that of a DCI format for downlink scheduling or that of a DCI format for sidelink scheduling; and determine, based on the DCI, scheduling information of a first channel for a base station device to transmit data to the electronic device and scheduling information of a second channel for the electronic device to forward the data to remote user equipment.

According to another aspect of the present disclosure, an electronic device is provided. The electronic device includes processing circuitry configured to: generate downlink control information (DCI) which includes scheduling information of a first channel for remote user equipment to transmit data to relay user equipment and scheduling information of a second channel for the relay user equipment to forward the data to the electronic device, and a size of which is the same as that of a DCI format for uplink scheduling or that of a DCI format for sidelink scheduling; and transmit the generated DCI to the remote user equipment.

According to another aspect of the present disclosure, an electronic device is provided. The electronic device includes processing circuitry configured to: receive downlink control information (DCI), a size of which is the same as that of a DCI format for uplink scheduling or that of a DCI format for sidelink scheduling; and determine, based on the DCI, scheduling information of a first channel for the electronic device to transmit data to relay user equipment and scheduling information of a second channel for the relay user equipment to forward the data to a base station device.

According to another aspect of the present disclosure, a wireless communication method executed by an electronic device. The method includes: generating downlink control information (DCI) which includes scheduling information of a first channel for the electronic device to transmit data to relay user equipment and scheduling information of a second channel for the relay user equipment to forward the data to remote user equipment, and a size of which is the same as that of a DCI format for downlink scheduling or that of a DCI format for sidelink scheduling; and transmitting the generated DCI to the relay user equipment.

According to another aspect of the present disclosure, a wireless communication method executed by an electronic device. The method includes: receiving downlink control information (DCI), a size of which is the same as that of a DCI format for downlink scheduling or that of a DCI format for sidelink scheduling; and determining, based on the DCI, scheduling information of a first channel for a base station device to transmit data to the electronic device and scheduling information of a second channel for the electronic device to forward the data to remote user equipment.

According to another aspect of the present disclosure, a wireless communication method executed by an electronic device. The method includes: generating downlink control information (DCI) which includes scheduling information of a first channel for remote user equipment to transmit data to relay user equipment and scheduling information of a second channel for the relay user equipment to forward the data to the electronic device, and a size of which is the same as that of a DCI format for uplink scheduling or that of a DCI format for sidelink scheduling; and transmitting the generated DCI to the remote user equipment.

According to another aspect of the present disclosure, a wireless communication method executed by an electronic device. The method includes: receiving downlink control information (DCI), a size of which is the same as that of a DCI format for uplink scheduling or that of a DCI format for sidelink scheduling; and determining, based on the DCI, scheduling information of a first channel for the electronic device to transmit data to relay user equipment and scheduling information of a second channel for the relay user equipment to forward the data to a base station device.

According to another aspect of the present disclosure, a computer readable storage medium is provided. The computer readable storage medium includes executable computer instructions that, when executed by a computer, causes the computer to execute the wireless communication method according to the present disclosure.

According to another aspect of the present disclosure, a computer program is provided. The computer program, when executed by a computer, causes the computer to execute the wireless communication method according to the present disclosure.

With the electronic device, the wireless communication method and the computer readable storage medium according to the present disclosure, a base station device may transmit DCI for downlink transmission to relay user equipment, wherein the DCI may include scheduling information of a first channel for the base station device to transmit data to the relay user equipment and scheduling information of a second channel for the relay user equipment to forward data to remote user equipment. In this way, the base station device can indicate scheduling information of two channels by simply transmitting DCI once, thereby simplifying resource scheduling process and reducing the delay of data transmission. Furthermore, the relay user equipment obtains resource scheduling information of two channels by simply demodulating once, such that power consumption of the relay user equipment can be reduced.

In addition, with the electronic device, the wireless communication method and the computer readable storage medium according to the present disclosure, a base station device can transmit DCI for uplink transmission to remote user equipment, wherein the DCI may include scheduling information of a first channel for the remote user equipment to transmit data to relay user equipment and scheduling information of a second channel for the relay user equipment to forward data to the base station device. In this way, the base station device can indicate scheduling information of two channels by simply transmitting DCI once, thereby simplifying resource scheduling process and reducing the delay of data transmission.

In the description herein, a further applicable area becomes apparent. The descriptions and specific examples in the summary are only illustrative and are not intended to limit the scope of the present disclosure.

### BRIEF DESCRIPTION OF THE DRAWINGS

The drawings are only used for illustrating the selected embodiments rather than all possible implementations, and are not intended to limit the scope of the present disclosure. In the drawings:

FIG. 1 is a schematic diagram showing an application scenario according to an embodiment of the present disclosure;

FIG. 2 is a flowchart showing signaling for performing downlink transmission by using relay UE in the conventional technology;

FIG. 3 is a schematic diagram showing an application scenario according to another embodiment of the present disclosure;

FIG. 4 is a flowchart showing signaling for performing uplink transmission by using relay UE in the conventional technology;

FIG. 5 is a block diagram showing an example of configuration of an electronic device as a network side device according to an embodiment of the present disclosure;

FIG. 6 is a flowchart showing signaling for performing downlink transmission by using relay UE according to an embodiment of the present disclosure;

FIG. 7 is a flowchart showing signaling for performing downlink transmission by using relay UE according to an embodiment of the present disclosure;

FIG. 8 is a flowchart showing signaling for performing downlink transmission by using relay UE according to an embodiment of the present disclosure;

FIG. 9 is a flowchart showing signaling for performing downlink transmission by using relay UE according to an embodiment of the present disclosure;

FIG. 10 is a flowchart showing signaling for performing downlink transmission by using relay UE according to an embodiment of the present disclosure;

FIG. 11 is a flowchart showing signaling for performing downlink transmission by using relay UE according to an embodiment of the present disclosure;

FIG. 12 is a block diagram showing an example of configuration of an electronic device as user equipment according to an embodiment of the present disclosure;

FIG. 13 is a flowchart showing signaling for performing uplink transmission by using relay UE according to an embodiment of the present disclosure;

FIG. 14 is a flowchart showing a wireless communication method executed by an electronic device as a network side device according to an embodiment of the present disclosure;

FIG. 15 is a flowchart showing a wireless communication method executed by an electronic device as user equipment according to an embodiment of the present disclosure;

FIG. 16 is a flowchart showing a wireless communication method executed by an electronic device as a network side device according to an embodiment of the present disclosure;

FIG. 17 is a flowchart showing a wireless communication method executed by an electronic device as user equipment according to an embodiment of the present disclosure;

FIG. 18 is a block diagram showing a first example of schematic configuration of an evolved node B (eNB);

FIG. 19 is a block diagram showing a second example of schematic configuration of an eNB;

FIG. 20 is a block diagram showing an example of a schematic configuration of a smartphone; and

FIG. 21 is a block diagram showing an example of schematic configuration of a vehicle navigation device.

Although various modification and alternations are easily made onto the present disclosure, the specific embodiments of the present disclosure are shown in the drawings as an example, and are described in detail here. However, it should be understood that description for the specific embodiments is not intended to limit the present disclosure into a disclosed specific form, and the present disclosure aims to cover all modification, equivalents and alternations within the spirit and scope of the present disclosure. It is noted that throughout the several figures, corresponding reference numerals indicate corresponding components.

### DETAILED DESCRIPTION OF EMBODIMENTS

Examples of the present disclosure are fully disclosed with reference to the drawings. The following description is merely exemplary and is not intended to limit the present disclosure and an application or use.

Exemplary embodiments are provided, such that the present disclosure becomes thorough and fully convey the scope thereof to those skilled in the art. Examples of specific components, apparatus, methods and other specific details are set forth to provide detailed understanding of embodiments of the present disclosure. It will be apparent to those skilled in the art that exemplary embodiments may be implemented in many different forms without the use of specific details, and should not be construed as limiting the scope of the present disclosure. In some exemplary embodiments, well-known processes, structures and technologies are not described in detail.

Description is made in the following order:

1. Description of a scenario;

2. Example of configuration of a network side device in downlink transmission;

3. Example of configuration of user equipment in downlink transmission;

4. Example of configuration of a network side device in uplink transmission;

5. Example of configuration of user equipment in uplink transmission;

6. Embodiments of methods; and

7. Examples of application.

### 1. DESCRIPTION OF A SCENARIO

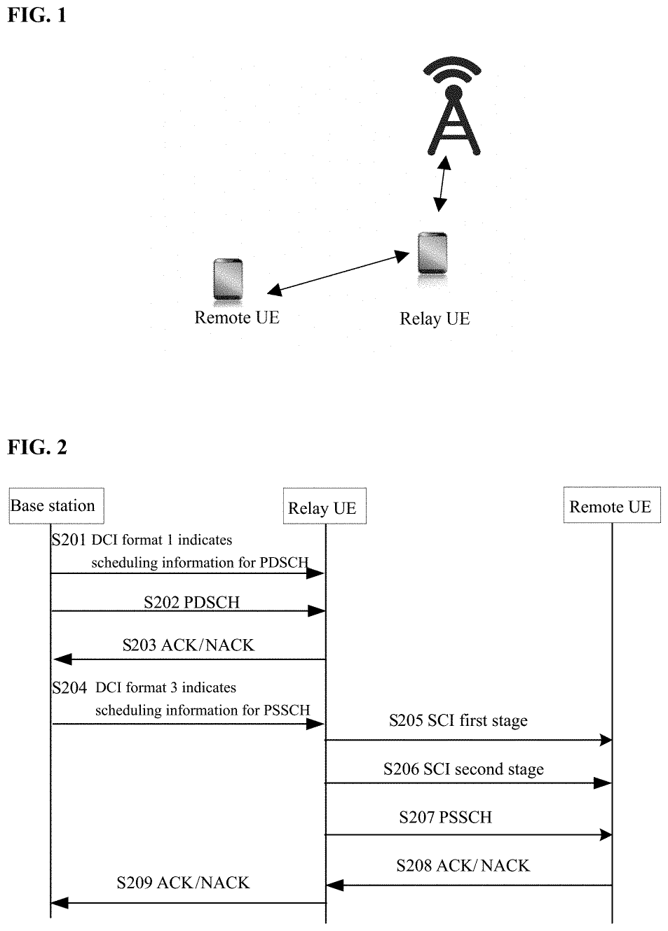

FIG. 1 is a schematic diagram showing an application scenario according to an embodiment of the present disclosure. As shown in FIG. 1, a base station device performs transmission with a remote UE via a relay UE (User Equipment). That is, in uplink transmission the relay UE forwards information from the remote UE to the base station device, and in downlink transmission the relay UE forwards information from the base station device to the remote UE.

FIG. 2 is a flowchart showing signaling for performing downlink transmission by using relay UE in the conventional technology. As shown in FIG. 2, in step S201, a base station transmits scheduling information for PDSCH (Physical Downlink Shared Channel) to relay UE in DCI format 1. Next, in step S202, the base station transmits downlink information for remote UE to the relay UE by using PDSCH. Next, in step S203, the relay UE feeds back feedback information for PDSCH, including ACK/NACK, to the base station. Next, in step S204, the base station transmits scheduling information for PSSCH (Physical SideLink Shared Channel) to the relay UE in DCI format 3. Next, in step S205 and step S206, the relay UE transmits SCI (SideLink Control Information) to the remote UE in two stages. Next, in step S207, the relay UE forwards downlink information from the base station to the remote UE by using PSSCH based on the received scheduling information of PSSCH. Next, in step S208, the remote UE transmits feedback information for the PSSCH, including ACK/NACK, to the relay UE. Next, in step S209, the relay UE forwards feedback information for PSSCH, including ACK/NACK, to the base station.

It can be seen that, in downlink transmission using relay technology, the base station transmits the scheduling information for PDSCH and the scheduling information for PSSCH to the relay UE in step S201 and step S204, respectively, which complicates the downlink transmission process and increases the delay of data transmission. In addition, the relay UE is required to demodulate scheduling information for PDSCH and the scheduling information for PSSCH, thereby increasing power consumption of the relay UE.

It should be noted that, although FIG. 1 shows a case in which relay UE is required in both uplink transmission and downlink transmission, FIG. 1 and FIG. 2 are mainly intended to show a scenario and signaling flow for downlink transmission, and whether relay UE is required in uplink transmission does not affect various embodiments of the present disclosure.

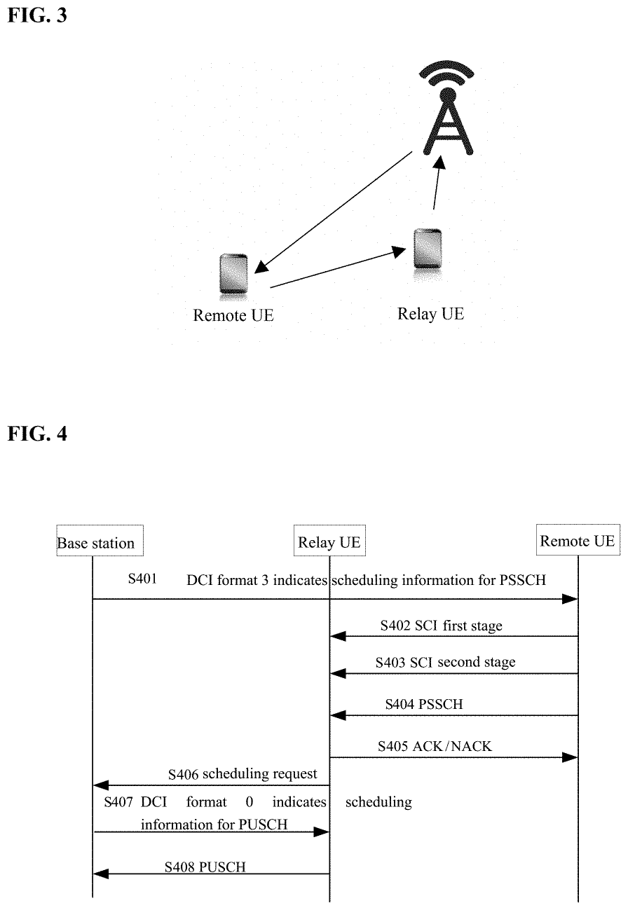

FIG. 3 is a schematic diagram showing an application scenario according to another embodiment of the present disclosure. As shown in FIG. 3, in uplink transmission relay UE forwards information from remote UE to a base station device, and in downlink transmission the base station device directly transmits information to the remote UE.

FIG. 4 is a flowchart showing signaling for performing uplink transmission by using relay UE in the conventional technology. As shown in FIG. 4, in step S401, a base station indicates scheduling information for PSSCH to remote UE in DCI format 3. In step S402 and step S403, the remote UE transmits SCI to the relay UE in two stages. Next, in step S404, the remote UE transmits uplink information to the relay UE by using the PSSCH based on the received scheduling information of PSSCH. Next, in step S405, the relay UE transmits feedback information for PSSCH, including ACK/NACK, to the remote UE. In step S406, the relay UE transmits a scheduling request to the base station. In step S407, the base station indicates scheduling information for PUSCH (Physical Uplink Shared Channel) to the relay UE in DCI format 0. In step S408, the relay UE forwards uplink information from the remote UE to the base station by using PUSCH based on the received scheduling information of PUSCH.

It can be seen that, in uplink transmission using relay technology, the base station transmits the scheduling information for PSSCH to the remote UE in step S401, and transmits the scheduling information for PUSCH to the relay UE in step S407, which complicates the uplink transmission process and increases the delay of data transmission.

It should be noted that, although FIG. 3 shows a case in which relay UE is required in uplink transmission and is not required in downlink transmission, FIG. 3 and FIG. 4 are mainly intended to show a scenario and signaling flow for uplink transmission, and whether relay UE is required in downlink transmission does not affect various embodiments of the present disclosure.

An electronic device in a wireless communication system, a wireless communication method executed by the electronic device in the wireless communication system, and a computer readable storage medium are proposed for such a scenario according to the present disclosure, to simplify the resource scheduling process in the data transmission procedure using relay technology, thereby reducing the delay.

The wireless communication system according to the present disclosure may be a 5G NR (New Radio) communication system. In addition, the wireless communication system according to the present disclosure may include TN (Terrestrial Network), and may also include NTN(Non-Terrestrial Network) and TN.

The wireless communication system according to the present disclosure utilizes the relay technology. That is, in uplink transmission the relay user equipment forwards information from the remote user equipment to the base station device, and in downlink transmission the relay user equipment forwards information from the base station device to the remote user equipment.

The network side device according to the present disclosure may be a base station device, for example, an eNB, or a gNB (a base station in the Fifth Generation communication system). In addition, the network side device according to the present disclosure may be a terrestrial network side device or a network side device located on a satellite device.

The user equipment according to the present disclosure may be a mobile terminal (such as a smartphone, a tablet personal computer (PC), a notebook PC, a portable game terminal, a portable/dongle mobile router and a digital camera) or an in-vehicle terminal (such as a vehicle navigation device). The user equipment may also be implemented as a terminal performing machine to machine (M2M) communication (also be referred to as a machine-type communication (MTC) terminal). In addition, the user equipment may be a wireless communication module (such as an integrated circuit module including a single wafer) installed on each of the terminals described above.

Further, in the present disclosure, DCI format 0 (DCI format 0) is used for uplink scheduling, and thus is referred to as DCI format for uplink scheduling. DCI format 0 includes but is not limited to DCI format 0_0, DCI format 0_1 and DCI format 0_2. DCI format 1 is used for downlink scheduling, and thus is referred to as DCI format for downlink scheduling. DCI format 1 includes but is not limited to DCI format 1_0, DCI format 1_1 and DCI format 1_2. DCI format 3 (DCI format 3) is used for sidelink scheduling, and thus is referred to as DCI format for sidelink scheduling. DCI format 3 includes but is not limited to DCI format 3_0 and DCI format 3_1. In addition, in the present disclosure, PUSCH refers to a channel for transmitting uplink data between user equipment and a base station device, PDSCH refers to a channel for transmitting downlink data between user equipment and a base station device, PSSCH refers to a channel for transmitting uplink data and downlink data between user equipment, and PSFCH refers to a channel for transmitting feedback information for PSSCH between user equipment.

### 2. EXAMPLE OF CONFIGURATION OF A NETWORK SIDE DEVICE IN DOWNLINK TRANSMISSION

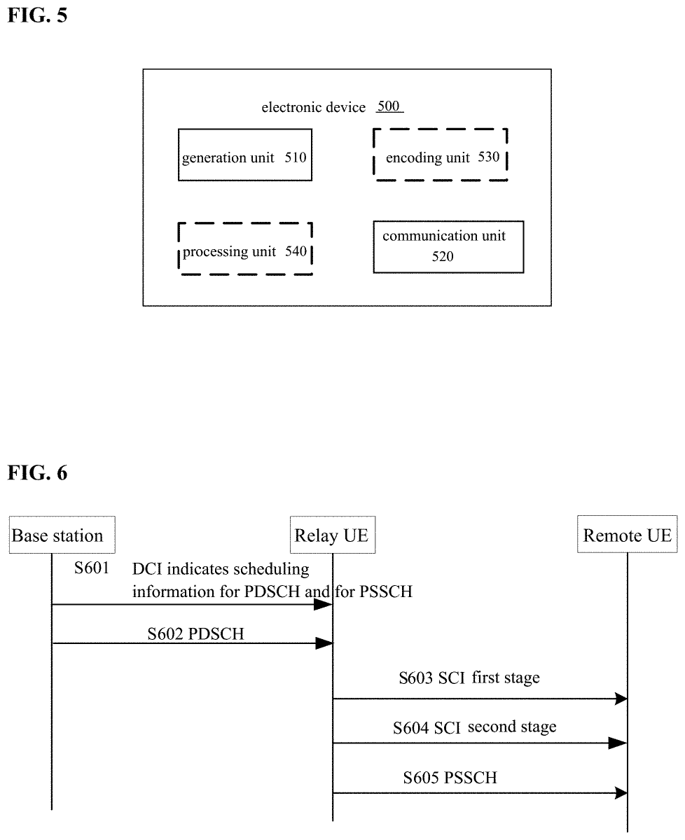

FIG. 5 is a block diagram showing an example of configuration of an electronic device 500 according to an embodiment of the present disclosure. The electronic device 500 here be used as a network side device in a wireless communication system, and specifically may be used as a base station device in the wireless communication system. A configuration of an electronic device 500 in downlink transmission will be described below.

As shown in FIG. 5, the electronic device 500 may include a generation unit 510 and a communication unit 520.

Here, each unit of the electronic device 500 may be included in processing circuitry. It should be noted that, the electronic device 500 may include one or more processing circuitry. Further, the processing circuitry may include various discrete functional units for performing various functions and/or operations. It should be noted that these functional units may be physical entities or logical entities, and units with different names may be implemented by a same physical entity.

According to an embodiment of the present disclosure, the generation unit 510 may generate DCI. The DCI includes scheduling information for downlink transmission. Specifically, the DCI includes scheduling information of a first channel for the electronic device 500 to transmit data to relay user equipment and scheduling information of a second channel for the relay user equipment to forward data to remote user equipment.

According to the embodiment of the present disclosure, a size of the DCI generated by the generation unit 510 is the same as that of a DCI format for downlink scheduling or a DCI format for sidelink scheduling.

According to the embodiment of the present disclosure, the electronic device 500 may transmit the DCI generated by the generation unit 510 to the relay user equipment via the communication unit 520.

It can be seen that, the electronic device 500 according to the embodiment of the present disclosure may transmit DCI for downlink transmission to the relay user equipment, which may include the scheduling information of the first channel for the electronic device 500 to transmit data to the relay user equipment and the scheduling information of the second channel for the relay user equipment to forward data to the remote user equipment. In this way, the electronic device 500 may indicate scheduling information of two channels by simply transmitting DCI once, thereby simplifying resource scheduling process and reducing the delay of data transmission. Furthermore, the relay user equipment obtains resource scheduling information of two channels by simply demodulating once, such that power consumption of the relay user equipment can be reduced.

It is well-known that, after receiving the DCI, the relay user equipment needs to perform blind detection on PDCCH (Physical Downlink Control Channel) that carries the DCI, that is, to decode the received DCI by using different RNTI (Radio Network Temporary Identity) and sizes of different DCI formats. Therefore, the number of size of DCI format affects the complexity of blind detection on relay user equipment. According to the embodiment of the present disclosure, since the size of the DCI generated by the generation unit 510 is the same as that of the DCI format for downlink scheduling or the DCI format for sidelink scheduling, a size of a new DCI format is not introduced, such that the complexity of blind detection on relay user equipment is not increased.

According to the embodiment of the present disclosure, the first channel is PDSCH and the second channel is PSSCH.

A configuration of the generation unit 510 according to the embodiment of the present disclosure when generating DCI for downlink transmission scheduling will be described below.

According to the embodiment of the present disclosure, the generation unit 510 may generate DCI to include fields in the DCI format for downlink scheduling and fields in the DCI format for sidelink scheduling which are not the same as those in the DCI format for downlink scheduling.

Here, the DCI format for downlink scheduling refers to a DCI format in which scheduling information of downlink between a base station device and user equipment is included, such as DCI format 1, including but not limited to DCI format 1_0, DCI format 1_1 and DCI format 1_2. That is, the user equipment may determine the reception of PDSCH based on the DCI format for downlink scheduling.

Contents of DCI format 1_1 are shown in the following table.

TABLE 1

| Description of Fields | Size (Bits) |
|---|---|
| Identifier for DCI formats | 1 |
| Carrier indicator | 0 or 3 |
| BWP indicator | 0, 1 or 2 |
| Frequency domain resource assignment | variable |
| Time domain resource assignment | 0, 1, 2, 3 or 4 |
| VPB-to-PRB mapping | 0 or 1 |
| PRB bundling | 0 or 1 |
| Rate matching indicator | 0, 1 or 2 |
| ZP CSI-RS trigger | 0, 1 or 2 |
| Modulation and coding scheme (for TB 1) | 5 |
| New data indicator (for TB 1) | 1 |
| Redundant version (for TB 1) | 2 |
| Modulation and coding scheme (for TB 2) | 5 |
| New data indicator (for TB 2) | 1 |
| Redundant version (for TB 2) | 2 |
| HARQ process ID | 4 |
| Downlink assignment index | 0, 2 or 4 |
| TPC command for scheduled PUCCH | 2 |
| PUCCH resource indicator | 3 |
| PDSCH-to-HARQ_feedback timing indicator | 0, 1, 2 or 3 |
| Antenna ports | 4, 5 or 6 |
| TCI | 0 or 3 |
| SRS request | 2 or 3 |
| CBGTI | 0 or 2, 4, 6, 8 |
| CBGFI | 0 or 1 |
| DMRS sequence initialization | 1 |

Here the DCI format for sidelink scheduling refers to a DCI format in which scheduling information of sidelink between user equipment is included, such as DCI format 3, including but not limited to DCI format 3_0, DCI format 3_1. That is, the receiving side user equipment may determine the reception of PSSCH based on the DCI format for sidelink scheduling.

Contents of DCI format 3_0 are shown in the following table.

TABLE 2

| Description of fields | Size |
|---|---|
| Time gap | x |
| HARQ process ID | x |
| New data indicator | 1 |
| Lowest index of sub-channel allocation to | |
| initial transmission | |
| SCI format 0-1 field: frequency domain | |
| resource assignment | |
| SCI format 0-1 field: time domain resource | |
| assignment | |
| PSFCH-to-HARQ_feedback timing indicator | 3 |
| PUCCH resource indicator | 3 |
| Configuration index | |

The necessary fields in DCI format 1_1 and DCI format 3_0 are shown in an exemplary manner as above, while other unnecessary fields are not shown. In addition, these examples are not restrictive. With the development of technology, DCI format 1_1 and DCI format 3_0 may also include other necessary fields.

According to the embodiment of the present disclosure, the DCI generated by the generation unit 510 includes all necessary fields in the DCI format for downlink scheduling and all necessary fields in the DCI format for sidelink scheduling. However, the generated DCI may include only one field for the same fields that are included in all necessary fields in the DCI format for downlink scheduling and all necessary fields in the DCI format for sidelink scheduling. Taking that the DCI format for downlink scheduling is DCI format 1_1 and the DCI format for sidelink scheduling is DCI format 3_0 as an example, both DCI format 1_1 and DCI format 3_0 include fields “new data indicator” and “HARQ process ID”, and thus, the DCI generated by the generation unit 510 may only include one field “new data indicator” and one field “HARQ process ID”.

According to the embodiment of the present disclosure, since the DCI including the scheduling information of two channels generated by the generation unit 510 includes all necessary fields in the DCI format for downlink scheduling and all necessary fields in the DCI format for sidelink scheduling, a size of a new DCI format is larger than that of the DCI format for downlink scheduling and that of the DCI format for sidelink scheduling.

According to the embodiment of the present disclosure, when generating the DCI format for downlink scheduling, the generation unit 510 may zero-pad the DCI format for downlink scheduling such that the size of the DCI format for downlink scheduling is the same as that of the generated new DCI. Here, the DCI format for downlink scheduling is DCI format 1, including but not limited to DCI format 1_0, DCI format 1_1 and DCI format 1_2.

According to the embodiment of the present disclosure, the generation unit 510 may zero-pad one or more of the DCI formats for downlink scheduling such that the size of one or more of the DCI formats for downlink scheduling is the same as that of the generated new DCI. For example, the generation unit 510 may zero-pad the DCI format 1_1 such that a size of the DCI format 1_1 is the same as that of the new DCI. As another example, the generation unit 510 may zero-pad both DCI format 1_1 and DCI format 1_0 such that sizes of DCI format 1_1 and DCI format 1_0 are the same as that of the new DCI.

According to the embodiment of the present disclosure, as shown in FIG. 5, the electronic device 500 may further include an encoding unit 530 configured to scramble the generated new DCI with RNTI.

The current RNTI includes two types of RNTI, namely RNTI for uplink and downlink and RNTI for sidelink. RNTI for uplink and downlink is mainly used to scramble a DCI format for uplink scheduling and a DCI format for downlink scheduling, that is, to scramble DCI format 0 and DCI format 1. RNTI for sidelink is mainly used to scramble a DCI format for sidelink scheduling, that is, to scramble DCI format 3.

According to the embodiment of the present disclosure, in a case that the generation unit 510 zero-pads the DCI format for downlink scheduling such that the size of the DCI format for downlink scheduling is the same as that of the generated new DCI, the encoding unit 530 may scramble the generated new DCI with RNTI for uplink and downlink.

According to the embodiment of the present disclosure, RNTI for uplink and downlink includes but not limited to, C-RNTI (Cell-RNTI), CS-RNTI (Configured Scheduling-RNTI) and MCS-C-RNTI (this RNTI is an unique user equipment identifier for indicating an optional MCS table of PDSCH and PUSCH).

As described above, the number of sizes of RNTI formats and DCI formats affects the complexity of blind detection on relay user equipment. At present, there are three sizes of DCI formats scrambled with RNTI for uplink and downlink, namely, the size of DCI format and DCI format 0_0, the size of DCI format 1_1 and DCI format 0_1, and the size of DCI format 1_2 and DCI format 0_2. According to the embodiment of the present disclosure, if the size of the new DCI generated by the generation unit 510 is the same as that of one of DCI format for downlink scheduling, the number of sizes of DCI formats scrambled with RNTI for uplink and downlink is still three, such that the complexity of blind detection on relay user equipment is not increased. According to the embodiment of the present disclosure, if the size of the new DCI generated by the generation unit 510 is the same as that of multiple of DCI formats for downlink scheduling, the number of sizes of DCI formats scrambled with RNTI for uplink and downlink is less than three, thereby further reducing the complexity of blind detection on relay user equipment.

According to the embodiment of the present disclosure, when generating the DCI format for sidelink scheduling, the generation unit 510 may zero-pad the DCI format for sidelink scheduling such that the size of the DCI format for sidelink scheduling is the same as that of the generated new DCI. Here, the DCI format for sidelink scheduling is DCI format 3, including but not limited to DCI format 3_0 and DCI format 3_1.

According to the embodiment of the present disclosure, the generation unit 510 may zero-pad one or more of DCI formats for sidelink scheduling such that the size of one or more of DCI formats for sidelink scheduling is the same as that of the generated new DCI. For example, the generation unit 510 may zero-pad the DCI format 3_1 such that the size of the DCI format 3_1 is the same as that of the new DCI. As another example, the generation unit 510 may zero-pad both DCI format 3_1 and DCI format 3_0 such that the sizes of DCI format 3_1 and DCI format 3_0 are the same as that of the new DCI.

According to the embodiment of the present disclosure, in a case that the generation unit 510 zero-pads the DCI format for sidelink scheduling such that the size of the DCI format for sidelink scheduling is the same as that of the generated new DCI, the encoding unit 530 may scramble the generated new DCI with the RNTI for sidelink.

According to the embodiment of the present disclosure, the RNTI for sidelink includes but not limited to, SL-RNTI (SideLink-RNTI) and SL-L-CS-RNTI (Side Link-LTE-Configured Scheduling-RNTI).

As described above, according to the embodiment of the present disclosure, if the size of the new DCI generated by the generation unit 510 is the same as that of one or more of DCI formats for sidelink scheduling, the number of sizes of DCI formats scrambled with RNTI for sidelink is unchanged or decreased, such that the complexity of blind detection on relay user equipment is not increased or can be reduced.

According to the embodiment of the present disclosure, the encoding unit 530 may also scramble the generated new DCI with RNTI different from RNTI for uplink and downlink and RNTI for sidelink. That is, the encoding unit 530 generates an RNTI dedicated to scrambling this DCI for downlink scheduling that includes scheduling information of two channels.

According to the embodiment of the present disclosure, the relay user equipment may support simultaneous scheduling of two TB (Transport Block). As shown in Table 1, DCI format 1_1 may include information for TB1 and information for TB2, and the information for each TB includes but not limited to modulation and coding scheme, new data indicator and redundant version. According to the embodiment of the present disclosure, the generation unit 510 may add a field for indicating TB indication information when generating a new DCI, and the TB indication information indicates that two TBs used for the relay user equipment are used for the first channel and the second channel, respectively. That is, the TB indication information may indicate which one of the two TBs is used for the first channel and which TB is used for the second channel. For example, the TB indication information may include 1 bit. When the TB indication information indicates 0, it is indicated that TB1 is used for the first channel and TB2 is used for the second channel, and when TB indication information indicates 1, it is indicated that TB1 is used for the second channel and TB2 is used for the first channel.

According to the embodiment of the present disclosure, the new DCI generated by the generation unit 510 may also implicitly represent TB indication information. For example, the electronic device 500 and the relay user equipment agree in advance that TB1 is used for the first channel and TB2 is used for the second channel, or agree that TB1 is used for the second channel and TB2 is used for the first channel.

As described above, according to the embodiment of the present disclosure, the generation unit 510 may zero-pad the DCI format for downlink scheduling such that the size of the DCI format for downlink scheduling is the same as that of the generated new DCI, or zero-pad the DCI format for sidelink scheduling such that the size of the DCI format for sidelink scheduling is the same as that of the generated new DCI. In this way, the operation of the relay process can be simplified and the delay of data transmission can be reduced without increasing the complexity of blind detection on the relay user equipment.

According to the embodiment of the present disclosure, the generation unit 510 may also generate a new DCI to include fields in a DCI format for downlink scheduling, such that a size of the DCI format for downlink scheduling is the same as that of the generated new DCI. Further, the generation unit 510 may represent the scheduling information of the first channel by using some fields in the DCI format for downlink scheduling, and represent the scheduling information of the second channel by using other fields in the DCI format for downlink scheduling

That is, the generation unit 510 may represent the scheduling information for the second channel by reusing some fields in the DCI format for downlink scheduling. Here, necessary information that may represent the scheduling information for the second channel includes but not limited to time domain resources and frequency domain resources for the second channel. For example, the generation unit 510 may represent the fields “time gap”, “lowest index of sub-channel allocation to initial transmission”, “SCI format 0-1 field: frequency domain resource assignment” and “SCI format 0-1 field: time domain resource assignment” in DCI format 3_0 respectively by using the fields “priority indication”, “channel access-Cpext”, “minimum applicable scheduling offset indication”, and “secondary cell sleep indication” in DCI format 1_1. Of course, the above example is not restrictive, and the generation unit 510 may also reuse other fields in the DCI format for downlink scheduling.

According to the embodiment of the present disclosure, the generation unit 510 may also indicate the above reusing with the indication information. For example, the generation unit 510 may represent the indication information by using a new field. Specifically, the generation unit 510 may also represent the above indication information with some fields in the DCI format for downlink scheduling. For example, if the parameters for one TB are all 1, the relay user equipment may determine that some fields in the DCI format for downlink scheduling are used to represent the scheduling information for the second channel instead of the original meaning.

According to the embodiment of the present disclosure, since the size of the DCI format for downlink scheduling is the same as that of the generated new DCI, the encoding unit 530 may scramble the generated new DCI with RNTI for uplink and downlink. In this way, the number of size of the DCI format scrambled with RNTI for uplink and downlink is still three, such that the complexity of blind detection on relay user equipment is not increased.

As described above, according to the embodiment of the present disclosure, the generation unit 510 may represent the information of the second channel by reusing some fields in the DCI format for downlink scheduling, such that the size of the DCI format for downlink scheduling is the same as that of the generated new DCI. In this way, the operation of the relay process can be simplified and the delay of data transmission can be reduced without increasing the complexity of blind detection on the relay user equipment.

FIG. 6 is a flowchart showing signaling for performing downlink transmission by using relay UE according to an embodiment of the present disclosure. As shown in FIG. 6, in step S601, a base station transmits DCI to relay UE, which includes scheduling information for PDSCH and scheduling information for PSSCH. Next, in step S602, the base station transmits data to the relay UE based on the scheduling information for PDSCH. Next, in step S603 and step S604, the relay UE transmits SCI to remote UE in two stages. Next, in step S605, the relay UE forwards data to the remote UE based on the scheduling information for PSSCH. Therefore, the base station can indicate scheduling information of two channels by simply transmitting DCI to the relay UE once, and the relay UE can obtain the scheduling information of two channels by simply demodulating once.

As shown in FIG. 5, according to an embodiment of the present disclosure, the electronic device 500 may further include a processing unit 540 configured to process feedback information from the relay user equipment. Here, the feedback information may include first feedback information of the relay user equipment to the first channel and second feedback information of the remote user equipment to the second channel.

According to the embodiment of the present disclosure, the DCI format for downlink transmission may include a feedback time for PDSCH, that is, an indication of the transmission time at which relay user equipment receives feedback information for the PDSCH from a base station device. For example, the field “PDSCH-to-HARQ feedback timing indicator” shown in Table 1 may indicate the feedback time for PDSCH. The DCI format for sidelink transmission may include a feedback time for PSFCH (Physical Side Link Feedback Channel), that is, an indication of transmission time at which user equipment at the receiving side receives feedback information for PSSCH from user equipment at the transmitting side. For example, the field “PSFCH-to-HARQ feedback timing indicator” shown in Table 2 may indicate the feedback time for PSFCH.

According to the embodiment of the present disclosure, the new DCI generated by the generation unit 510 may include only the feedback time for the PSFCH, not the feedback time for the PDSCH, or includes both the feedback time for the PSFCH and the feedback time for the PDSCH.

According to the embodiment of the present disclosure, in a case that the new DCI only includes the feedback time for PSFCH, when the relay user equipment does not successfully receive data from the electronic device 500, the electronic device 500 may receive the first feedback information and the second feedback information from the relay user equipment at the feedback time for PSFCH. In this case, the relay user equipment may not forward the data to the remote user equipment, but directly feed back to the electronic device 500 at the feedback time for PSFCH. Here, since the relay user equipment does not successfully receive the data from the electronic device 500, the first feedback information may be NACK, and since the relay user equipment does not forward the data to the remote user equipment, the second feedback information may also be NACK.

According to the embodiment of the present disclosure, the electronic device 500 may receive compressed first feedback information and second feedback information from the relay user equipment at the feedback time for PSFCH. For example, the first feedback information and the second feedback information may be compressed as NACK. Specifically, the electronic device 500 may also receive uncompressed first feedback information and second feedback information from the relay user equipment at the feedback time for PSFCH. For example, the first feedback information is NACK and the second feedback information is also NACK. That is, the relay user equipment may report feedback information of two channels at one time.

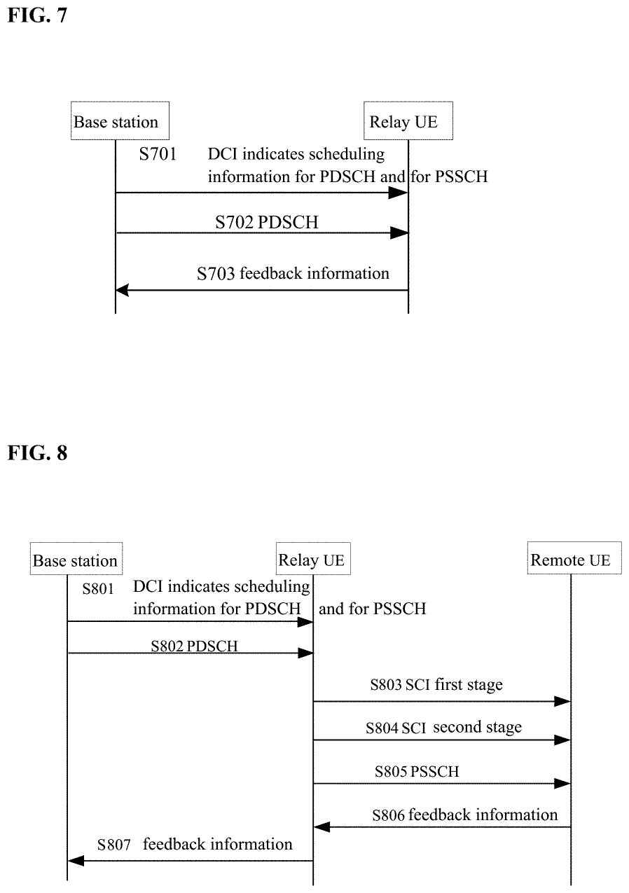

FIG. 7 is a flowchart showing signaling for performing downlink transmission by using relay UE according to an embodiment of the present disclosure. In the example shown in FIG. 7, the new DCI only includes the feedback time for the PSFCH, and the relay UE does not successfully receive the data from the base station. As shown in FIG. 7, in step S701, a base station transmits DCI to relay UE, which includes scheduling information for PDSCH and scheduling information for PSSCH. Next, in step S702, the base station transmits PDSCH to the relay UE based on the scheduling information for PDSCH. Next, since the relay UE does not successfully receive the PDSCH, the relay UE does not forward the data. Instead, in step S703, the relay UE transmits feedback information, including for example compressed NACK or uncompressed NACK and NACK, to the base station at the feedback time for PSFCH.

According to the embodiment of the present disclosure, in a case that the new DCI only includes the feedback time for PSFCH, when the relay user equipment successfully receives data from the electronic device 500, the relay user equipment may forward the data to the remote user equipment based on the scheduling information of the second channel included in the DCI. Further, the electronic device 500 may receive the first feedback information and the second feedback information from the relay user equipment at the feedback time for PSFCH.

Here, the relay user equipment may generate first feedback information, including ACK, for example. In addition, the relay user equipment may receive second feedback information of the remote user equipment to the second channel from the remote user equipment, including ACK or NACK.

According to the embodiment of the present disclosure, the electronic device 500 may receive compressed first feedback information and second feedback information from the relay user equipment at the feedback time for PSFCH. For example, when the second feedback information reported by the remote user equipment is ACK, the first feedback information and the second feedback information may be compressed as ACK, and when the second feedback information reported by the remote user equipment is NACK, the first feedback information and the second feedback information may be compressed as NACK. Specifically, the electronic device 500 may also receive uncompressed first feedback information and second feedback information from the relay user equipment at the feedback time for PSFCH. For example, the first feedback information is ACK and the second feedback information is ACK or NACK. That is, the relay user equipment may report the feedback information of two channels at one time.

As described above, the relay user equipment may feed back the first feedback information and the second feedback information to the electronic device 500 at the feedback time for PSFCH. In this way, instead of feeding back the first feedback information before forwarding data, the relay user equipment forwards the data before feeding back the first feedback information and the second feedback information, thereby reducing the delay of data transmission to the remote user equipment.

FIG. 8 is a flowchart showing signaling for performing downlink transmission by using relay UE according to an embodiment of the present disclosure. In the example shown in FIG. 8, the new DCI only includes a feedback time for PSFCH, and relay UE successfully receives data from a base station. As shown in FIG. 8, in step S801, the base station transmits DCI to the relay UE, which indicates scheduling information for PDSCH and scheduling information for PSSCH. Next, in step S802, the base station transmits PDSCH to the relay UE based on the scheduling information for PDSCH. It is assumed that the relay UE successfully receives data from the base station. In step S803 and step S804, the relay UE transmits SCI to remote UE in two stages. Next, in step S805, the relay UE transmits PSSCH to the remote UE based on the scheduling information for PSSCH. Next, in step S806, the remote UE transmits feedback information to the relay UE based on the reception result of PSSCH. For example, in a case of successful reception of PSSCH, ACK is fed back, and in a case of unsuccessful reception of PSSCH, NACK is fed back. Next, in step S807 the relay UE transmits feedback information, including uncompressed ACK and ACK/NACK or compressed ACK/NACK, to the base station at the feedback time for PSFCH.

As described above, according to the embodiment of the present disclosure, when the new DCI only includes the feedback time for PSFCH, the electronic device 500 may receive the first feedback information for the first channel and the second feedback information for the second channel from the relay UE at the feedback time for PSFCH.

According to the embodiment of the present disclosure, when the new DCI includes both the feedback time for PSFCH and the feedback time for PDSCH, the electronic device 500 may receive the first feedback information from the relay user equipment at the feedback time for PDSCH and receive the second feedback information from the relay user equipment at the feedback time for PSFCH.

According to the embodiment of the present disclosure, when the new DCI includes both the feedback time for PSFCH and the feedback time for PDSCH, if the relay user equipment does not successfully receive data from the electronic device 500, the first feedback information may be NACK. Further, the relay user equipment may not forward data to the remote user equipment, and thus the second feedback information may also be NACK.

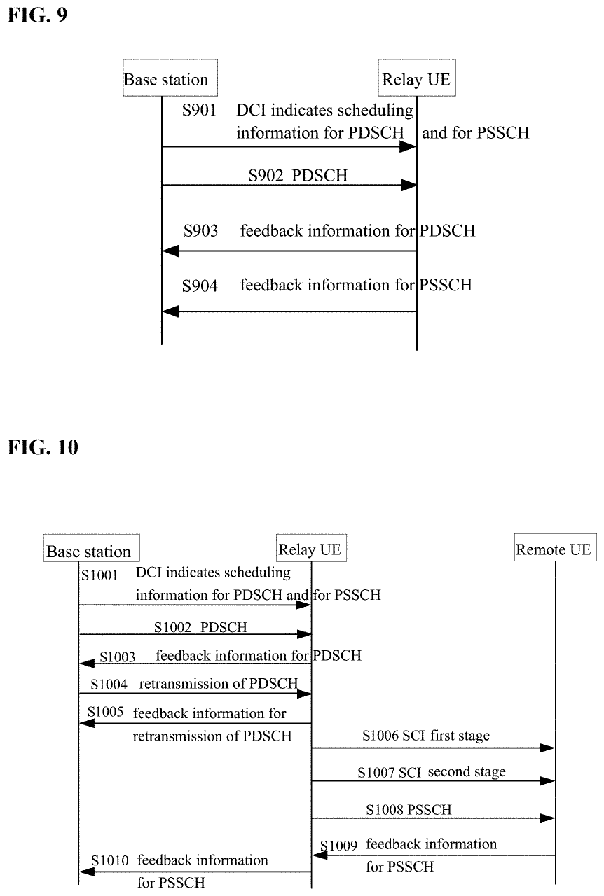

FIG. 9 is a flowchart showing signaling for performing downlink transmission by using relay UE according to an embodiment of the present disclosure. In FIG. 9, the new DCI includes both a feedback time for PSFCH and a feedback time for PDSCH, and relay UE does not successfully receive data from a base station. As shown in FIG. 9, in step S901, the base station transmits DCI to the relay UE, which indicates scheduling information for PDSCH and scheduling information for PSSCH. Next, in step S902, the base station transmits PDSCH to the relay UE based on the scheduling information for PDSCH. Here, it is assumed that the relay UE does not successfully receive data from the base station. The relay UE does not forward the data to remote UE, and in step S903, the relay UE transmits first feedback information, such as NACK, to the base station at the feedback time for PDSCH. In step S904, the relay UE transmits second feedback information, such as NACK, to the base station at the feedback time for PSFCH.

According to the embodiment of the present disclosure, when the new DCI includes both the feedback time for PSFCH and the feedback time for PDSCH, if the relay user equipment does not successfully receive data from the electronic device 500, the relay user equipment may transmit the first feedback information to the electronic device 500 at the feedback time for PDSCH. Further, if the feedback time for PSFCH is relatively long, the relay user equipment may also wait for the retransmission data from the electronic device 500, and forward the retransmission data to the remote user equipment if the retransmission data is successfully received, and the relay user equipment feeds back the second feedback information at the feedback time for PSFCH based on the reception result of the retransmission data by the remote user equipment.

FIG. 10 is a flowchart showing signaling for performing downlink transmission by using relay UE according to an embodiment of the present disclosure. In FIG. 10, the new DCI includes both a feedback time for PSFCH and a feedback time for PDSCH, and relay UE does not successfully receive data of initial transmission from a base station but successfully receives retransmission data from the base station. As shown in FIG. 10, in step S1001, the base station transmits DCI to the relay UE, which indicates scheduling information for PDSCH and scheduling information for PSSCH. Next, in step S1002, the base station transmits PDSCH to the relay UE based on the scheduling information for PDSCH. Here, it is assumed that the relay UE does not successfully receive data from the base station. In step S1003, the relay UE transmits first feedback information, such as NACK, to the base station at the feedback time for PDSCH. Next, in step S1004, the base station retransmits PDSCH to the relay UE. Next, in step S1005, the relay UE transmits the first feedback information, such as ACK, to the base station at the feedback time for PDSCH. In step S1006 and step S1007, the relay UE transmits SCI to remote UE in two stages. In step S1008, the relay UE forwards the retransmitted data to the remote UE based on the scheduling information for PSSCH. In step S1009, the remote UE transmits feedback information for PSSCH, including ACK or NACK, to the relay UE based on the reception result of the retransmission data. In step S1010, the relay UE transmits second feedback information, including ACK or NACK, to the base station at the feedback time for PSFCH.

According to the embodiment of the present disclosure, when the new DCI includes both the feedback time for PSFCH and the feedback time for PDSCH, if the relay user equipment successfully receives data from the electronic device 500, the relay user equipment may transmit the first feedback information, which may be ACK, to the electronic device 500 at the feedback time for PDSCH, and may transmit the second feedback information, which may be ACK/NACK, to the electronic device 500 at the feedback time for PSFCH.

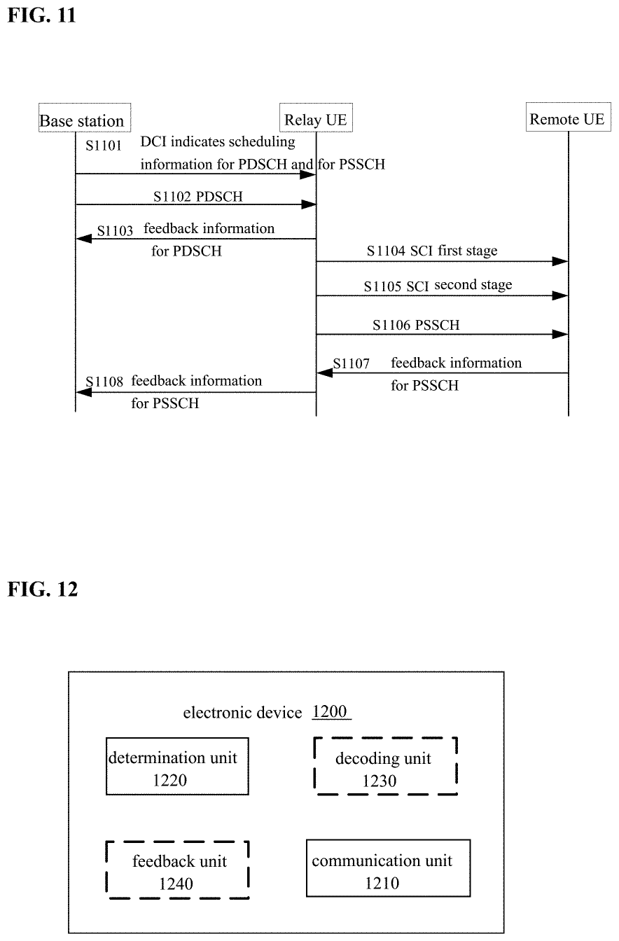

FIG. 11 is a flowchart showing signaling for performing downlink transmission by using relay UE according to an embodiment of the present disclosure. In FIG. 11, the new DCI includes both a feedback time for PSFCH and a feedback time for PDSCH, and relay UE successfully receives data from a base station. As shown in FIG. 11, in step S1101, the base station transmits DCI to the relay UE, which indicates scheduling information for PDSCH and scheduling information for PSSCH. Next, in step S1102, the base station transmits PDSCH to the relay UE based on the scheduling information for PDSCH. Here, it is assumed that the relay UE successfully receives data from the base station. In step S1103, the relay UE transmits first feedback information, such as ACK, to the base station at the feedback time for PDSCH. Next, in step S1104 and step S1105, the relay UE transmits SCI to remote UE in two stages. In step S1106, the relay UE forwards data to the remote UE based on the scheduling information for PSSCH. In step S1107, the remote UE transmits feedback information for PSSCH, including ACK or NACK, to the relay UE based on a reception result of the data. In step S1108, the relay UE transmits second feedback information, including ACK or NACK, to the base station at the feedback time for PSFCH.

As described above, according to the embodiment of the present disclosure, when the new DCI includes both the feedback time for PSFCH and the feedback time for PDSCH, the electronic device 500 may receive the first feedback information from the relay user equipment at the feedback time for PDSCH and receive the second feedback information from the relay user equipment at the feedback time for PSFCH.

It can be seen that, according to the embodiment of the present disclosure, the electronic device 500 can indicate scheduling information of two channels by simply transmitting DCI once, and the relay user equipment can obtain resource scheduling information of two channels by simply demodulating once, such that the power consumption of the relay user equipment can be reduced. In addition, the electronic device 500 may zero-pad the DCI format for downlink scheduling such that the size of the DCI format for downlink scheduling is the same as that of the generated new DCI, or zero-pad the DCI format for sidelink scheduling such that the size of the DCI format for sidelink scheduling is the same as that of the generated new DCI. Specifically, the generation unit 510 may represent the information of the second channel by reusing some fields in the DCI format for downlink scheduling, such that the size of the DCI format for downlink scheduling is the same as that of the generated new DCI. Further, if the new DCI only includes the feedback time for PSFCH, the electronic device 500 may receive the first feedback information for the first channel and the second feedback information for the second channel from the relay UE at the feedback time for PSFCH, and if the new DCI includes both the feedback time for PSFCH and the feedback time for PDSCH, the electronic device 500 may receive the first feedback information from the relay user equipment at the feedback time for PDSCH and receive the second feedback information from the relay user equipment at the feedback time for PSFCH. In summary, the electronic device 500 according to the embodiment of the present disclosure may simplify the resource scheduling process and reduce the delay of data transmission without increasing the complexity of blind detection on the relay user equipment.

### 3. EXAMPLE OF CONFIGURATION OF USER EQUIPMENT IN DOWNLINK TRANSMISSION

FIG. 12 is a block diagram showing a structure of an electronic device 1200 as user equipment in a wireless communication system according to an embodiment of the present disclosure. A configuration of the electronic device 1200 as relay user equipment in downlink transmission will be described below.

As shown in FIG. 12, the electronic device 1200 may include a communication unit 1210 and a determination unit 1220.

Here, each unit of the electronic device 1200 may be included in processing circuitry. It should be noted that, the electronic device 1200 may include one or more processing circuitry. Further, the processing circuitry may include various discrete functional units for performing various functions and/or operations. It should be noted that these functional units may be physical entities or logical entities, and units with different names may be implemented by a same physical entity.

According to an embodiment of the present disclosure, the electronic device 1200 may receive DCI from a base station device via the communication unit 1210, and a size of DCI is the same as that of a DCI format for downlink scheduling or that of a DCI format for sidelink scheduling.

According to the embodiment of the present disclosure, the determination unit 1220 may determine, based on the received DCI, scheduling information of a first channel for the base station device to transmit data to the electronic device 1200 and scheduling information of a second channel for the electronic device 1200 to forward the data to remote user equipment.

As described above, according to the embodiment of the present disclosure, the electronic device 1200 may obtain resource scheduling information of two channels by demodulating once, such that the power consumption of the electronic device 1200 can be reduced, the relay transmission process is simplified, and the delay in forwarding data to the remote user equipment is reduced.

According to an embodiment of the present disclosure, the electronic device 1200 may receive data from the base station device based on the scheduling information of the first channel. For example, the electronic device 1200 may determine time-frequency resources occupied by the data from the base station device based on the scheduling information of the first channel. Further, the electronic device 1200 may forward the data to the remote user equipment based on the scheduling information of the second channel. For example, the electronic device 1200 may determine time-frequency resources for forwarding the data to the remote user equipment based on the scheduling information of the second channel.

According to the embodiment of the present disclosure, the first channel is PDSCH and the second channel is PSSCH.

According to an embodiment of the present disclosure, the DCI received by the electronic device 1200 may include fields in the DCI format for downlink scheduling, and fields in the DCI format for sidelink scheduling which are not the same as those in the DCI format for downlink scheduling.

According to the embodiment of the present disclosure, the determination unit 1220 may determine the scheduling information of the first channel based on the fields in the DCI format for downlink scheduling, and may determine the scheduling information of the second channel based on the fields in the DCI format for sidelink scheduling which are not the same as those in the DCI format for downlink scheduling.

According to an embodiment of the present disclosure, as shown in FIG. 12, the electronic device 1200 may further include a decoding unit 1230 configured to descramble DCI with RNTI.

According to the embodiment of the present disclosure, the decoding unit 1230 may descramble the DCI with RNTI for uplink and downlink, RNTI for sidelink, or RNTI different from the RNTI for uplink and downlink and the RNTI for sidelink link.

Further, according to the embodiment of the present disclosure, if the decoding unit 1230 successfully descrambles the DCI with RNTI for uplink and downlink, the determination unit 1220 may further determine that the DCI which is not zero-padded is a DCI including the scheduling information of two channels, while the DCI which is zero-padded is a DCI for downlink scheduling. According to the embodiment of the present disclosure, if that the decoding unit 1230 successfully descrambles the DCI with RNTI for sidelink, the determination unit 1220 may further determine that the DCI which is not zero-padded is a DCI including the scheduling information of two channels, while the DCI which is zero-padded is a DCI for sidelink scheduling. If the decoding unit 1230 successfully descrambles the DCI with RNTI different from RNTI for uplink and downlink and RNTI for sidelink, the determination unit 1220 may directly determine that the DCI is a DCI including the scheduling information of two channels.

As described above, according to the embodiment of the present disclosure, the size of the DCI format for downlink scheduling is the same as that of the new DCI, or the size of the DCI format for sidelink scheduling is the same as that of the new DCI, such that the complexity of blind detection on the electronic device 1200 is not increased.

According to the embodiment of the present disclosure, the determination unit 1220 may also determine that two TBs used for the electronic device 1200 are used for the first channel and the second channel, respectively, based on the TB indication information included in the DCI. For example, the determination unit 1220 may determine the TB indication information based on the field for TB indication information included in the DCI. In addition, the electronic device 1200 may also agree with the network side device which TB is used for the first channel and which TB is used for the second channel.

According to the embodiment of the present disclosure, the received DCI may include fields in the DCI format for downlink scheduling.

According to the embodiment of the present disclosure, the determination unit 1220 may determine the scheduling information of the first channel based on some fields in the DCI format for downlink scheduling, and determine the scheduling information of the second channel based on other fields in the DCI format for downlink scheduling.

According to the embodiment of the present disclosure, the decoding unit 1230 may descramble DCI with RNTI for uplink and downlink and RNTI for sidelink. Further, if the decoding unit 1230 successfully descrambles the DCI with RNTI for uplink and downlink, the determination unit 1220 may determine whether the DCI is a new DCI that includes scheduling information of two channels or a DCI for downlink scheduling, based on a field in the DCI indicating whether the DCI is a new DCI that includes the scheduling information of two channels.

For example, when the field including the above indication indicates 1, the determination unit 1220 may determine that some fields in the DCI format for downlink scheduling are used to represent the scheduling information for the second channel instead of the original meaning. Specifically, the above indication may be represented by using the original field in the DCI format for downlink scheduling. For example, if the parameters for one TB in the DCI are all 1, the determination unit 1220 may determine that some fields in the DCI format for downlink scheduling are used to represent the scheduling information for the second channel instead of the original meaning. As one example, the determination unit 1220 may represent the fields “time gap”, “lowest index of sub-channel allocation to initial transmission”, “SCI format 0-1 field: frequency domain resource assignment” and “SCI format 0-1 field: time domain resource assignment” in DCI format 3_0 respectively by using the fields “priority indication”, “channel access-Cpext”, “minimum applicable scheduling offset indication”, and “secondary cell sleep indication” in DCI format 1_1. That is, the determination unit 1220 may determine the scheduling information of the second channel based on the above fields. Of course, the above example is not restrictive, and other fields in the DCI format for downlink scheduling may also be reused.

As described above, according to the embodiment of the present disclosure, the size of the DCI format for downlink scheduling is the same as that of the new DCI, such that the complexity of blind detection on the electronic device 1200 is not increased.

According to an embodiment of the present disclosure, as shown in FIG. 12, the electronic device 1200 may further include a feedback unit 1240 configured to transmit feedback information to the base station device, and the feedback information may include first feedback information of the electronic device 1200 with respect to the first channel and second feedback information of the remote user equipment with respect to the second channel.

According to the embodiment of the present disclosure, when the received DCI only includes the feedback time for PSFCH, the determination unit 1220 may determine the feedback time for PSFCH based on the DCI. Further, the electronic device 1200 may transmit the first feedback information and the second feedback information to the base station device at the feedback time for PSFCH.

According to the embodiment of the present disclosure, if the electronic device 1200 does not successfully receive data from the base station device, the electronic device 1200 may not forward the data to the remote user equipment. In this case, the first feedback information is NACK, and the second feedback information may also be NACK. Here, the feedback unit 1240 may compress the first feedback information and the second feedback information, to transmit the compressed NACK at the feedback time for PSFCH. Specifically, the feedback unit 1240 may not compress the first feedback information and the second feedback information, so as to transmit NACK and NACK at the feedback time for PSFCH.

According to the embodiment of the present disclosure, if the electronic device 1200 successfully receives data from the base station device, the electronic device 1200 may forward the data to the remote user equipment based on the scheduling information for the second channel in the DCI. In this case, the first feedback information is ACK, and the feedback unit 1240 may determine that the second feedback information is ACK or NACK based on the feedback information from the remote user equipment. Here, the feedback unit 1240 may compress the first feedback information and the second feedback information, to transmit the compressed ACK at the feedback time for PSFCH when the second feedback information is ACK, and transmit the compressed NACK at the feedback time for PSFCH when the second feedback information is NACK. Specifically, the feedback unit 1240 may not compress the first feedback information and the second feedback information, so as to transmit ACK and ACK/NACK at the feedback time for PSFCH.

As described above, according to the embodiment of the present disclosure, the electronic device 1200 may first forward data to the remote user equipment, and then transmit the first feedback information and the second feedback information to the base station device at the feedback time for PSFCH, thereby reducing the delay in forwarding data to the remote user equipment.

According to the embodiment of the present disclosure, when the received DCI includes a feedback time for PSFCH and a feedback time for PDSCH, the determination unit 1220 may determine the feedback time for PDSCH and feedback time for PSFCH based on the DCI. Further, the electronic device 1200 may transmit the first feedback information to the base station device at the feedback time for PDSCH and transmit the second feedback information to the base station device at the feedback time for PSFCH.

According to the embodiment of the present disclosure, if the electronic device 1200 does not successfully receive data from the base station device, the electronic device 1200 may not forward the data to the remote user equipment, and transmit the first feedback information, such as NACK, at the feedback time for PDSCH and transmit the second feedback information, such as NACK, at the feedback time for PSFCH.

According to the embodiment of the present disclosure, if the electronic device 1200 does not successfully receive data from the base station device, the electronic device 1200 may transmit the first feedback information, such as NACK, at the feedback time for PDSCH, and then wait for the retransmission data from the base station device. If the electronic device 1200 successfully receives the retransmission data, the electronic device 1200 forwards the retransmission data to the remote user equipment, and the feedback unit 1240 may determine whether the second feedback information is ACK or NACK based on the feedback information from the remote user equipment. Further, the electronic device 1200 may transmit the second feedback information, such as ACK/NACK, at the feedback time for PSFCH.

According to the embodiment of the present disclosure, if the electronic device 1200 successfully receives data from the base station device, the electronic device 1200 may transmit the first feedback information, such as ACK, at the feedback time for PDSCH. Further, the electronic device 1200 may forward the data to the remote user equipment, and the feedback unit 1240 may determine that the second feedback information is ACK or NACK based on the feedback information from the remote user equipment. Further, the electronic device 1200 may transmit the second feedback information, such as ACK/NACK, at the feedback time for PSFCH.

The electronic device 500 as a network side device and the electronic device 1200 as relay user equipment are described above, that is, the electronic device 1200 may forward downlink information from the electronic device 500 to the remote user equipment.

### 4. EXAMPLE OF CONFIGURATION OF A NETWORK SIDE DEVICE IN UPLINK TRANSMISSION

A configuration of an electronic device 500 as a network side device in uplink transmission is described below, still with reference to FIG. 5. The network side device may be, for example, a base station device.

According to an embodiment of the present disclosure, the generation unit 510 may generate DCI, which is used for uplink scheduling. Specifically, DCI includes scheduling information of a first channel for remote user equipment to transmit data to relay user equipment and scheduling information of a second channel for the relay user equipment to forward the data to the electronic device 500.

According to the embodiment of the present disclosure, a size of DCI is the same as that of a DCI format for uplink scheduling or a DCI format for sidelink scheduling.

According to the embodiment of the present disclosure, the electronic device 500 may transmit the generated DCI to the remote user equipment via the communication unit 520.

As described above, according to the embodiment of the present disclosure, the electronic device 500 may carry scheduling information of the first channel and the second channel by simply transmitting the DCI once, such that relay transmission process is simplified and the delay of data transmission is reduced.

According to the embodiment of the present disclosure, the first channel is PSSCH and the second channel is PUSCH.

According to the embodiment of the present disclosure, the DCI generated by the generation unit 510 may include fields in the DCI format for uplink scheduling, and fields in the DCI format for sidelink scheduling which are not the same as those in the DCI format for uplink scheduling.

Here, the DCI format for uplink scheduling refers to a DCI format in which scheduling information of uplink between a base station device and user equipment is included, such as DCI format 0, including but not limited to DCI format 0_0, DCI format 0_1 and DCI format 0_2. That is, the user equipment may determine the transmission of PUSCH based on the DCI format for uplink scheduling.

Here, the DCI format for sidelink scheduling refers to a DCI format in which scheduling information of sidelink between user equipment is included, such as DCI format 3, including but not limited to DCI format 3_0, DCI format 3_1. That is, the transmitting side user equipment may determine the transmission of PSSCH based on the DCI format for sidelink scheduling.

According to the embodiment of the present disclosure, the DCI generated by the generation unit 510 includes all necessary fields in the DCI format for uplink scheduling and all necessary fields in the DCI format for sidelink scheduling. However, the generated DCI may include only one field for the same fields that are included in all necessary fields in the DCI format for uplink scheduling and all necessary fields in the DCI format for sidelink scheduling.

According to the embodiment of the present disclosure, since the DCI including the scheduling information of two channels generated by the generation unit 510 includes all necessary fields in the DCI format for uplink scheduling and all necessary fields in the DCI format for sidelink scheduling, a size of a new DCI format is larger than that of the DCI format for uplink scheduling and that of the DCI format for sidelink scheduling.

According to the embodiment of the present disclosure, the generation unit 510 may zero-pad the DCI format for uplink scheduling such that the size of the DCI format for uplink scheduling is the same as that of the generated new DCI. Here, the DCI format for uplink scheduling is DCI format 0, including but not limited to DCI format 0_0, DCI format 0_1 and DCI format 0_2.

According to the embodiment of the present disclosure, the generation unit 510 may zero-pad one or more of the DCI formats for uplink scheduling such that the size of one or more of the DCI formats for uplink scheduling is the same as that of the generated new DCI. For example, the generation unit 510 may zero-pad the DCI format 0_1 such that a size of the DCI format 0_1 is the same as that of the new DCI. As another example, the generation unit 510 may zero-pad both DCI format 0_1 and DCI format 0_0 such that sizes of DCI format 0_1 and DCI format 0_0 are the same as that of the new DCI.

According to the embodiment of the present disclosure, in a case that the generation unit 510 zero-pads the DCI format for uplink scheduling such that the size of the DCI format for uplink scheduling is the same as that of the generated new DCI, the encoding unit 530 may scramble the generated new DCI with RNTI for uplink and downlink. According to the embodiment of the present disclosure, RNTI for uplink and downlink includes but not limited to C-RNTI, CS-RNTI and MCS-C-RNTI.

According to the embodiment of the present disclosure, in a case that the size of the new DCI generated by the generation unit 510 is the same as that of one of DCI format for uplink scheduling, the number of sizes of DCI formats scrambled with RNTI for uplink and downlink is still three, such that the complexity of blind detection on remote user equipment is not increased. According to the embodiment of the present disclosure, in a case that the size of the new DCI generated by the generation unit 510 is the same as that of multiple of DCI formats for uplink scheduling, the number of sizes of DCI formats scrambled with RNTI for uplink and downlink is less than three, thereby further reducing the complexity of blind detection on remote user equipment.

According to the embodiment of the present disclosure, when generating the DCI format for sidelink scheduling, the generation unit 510 may zero-pad the DCI format for sidelink scheduling such that the size of the DCI format for sidelink scheduling is the same as that of the generated new DCI. Here, the DCI format for sidelink scheduling is DCI format 3, including but not limited to DCI format 3_0 and DCI format 3_1.

According to the embodiment of the present disclosure, the generation unit 510 may zero-pad one or more of DCI formats for sidelink scheduling such that the size of one or more of DCI formats for sidelink scheduling is the same as that of the generated new DCI. For example, the generation unit 510 may zero-pad the DCI format 3_1 such that the size of the DCI format 3_1 is the same as that of the new DCI. As another example, the generation unit 510 may zero-pad both DCI format 3_1 and DCI format 3_0 such that the sizes of DCI format 3_1 and DCI format 3_0 are the same as that of the new DCI.

According to the embodiment of the present disclosure, in a case that the generation unit 510 zero-pads the DCI format for sidelink scheduling such that the size of the DCI format for sidelink scheduling is the same as that of the generated new DCI, the encoding unit 530 may scramble the generated new DCI with the RNTI for sidelink. According to the embodiment of the present disclosure, RNTI for sidelink includes but not limited to SL-RNTI and SL-L-RNTI.

As described above, according to the embodiment of the present disclosure, if the size of the new DCI generated by the generation unit 510 is the same as that of one or more of DCI formats for sidelink scheduling, the number of sizes of DCI formats scrambled with RNTI for sidelink is unchanged or decreased, such that the complexity of blind detection on remote user equipment is not increased or can be reduced.

According to the embodiment of the present disclosure, the encoding unit 530 may also scramble the generated new DCI with RNTI different from RNTI for uplink and downlink and RNTI for sidelink. That is, the encoding unit 530 generates an RNTI dedicated to scrambling this DCI for uplink scheduling that includes scheduling information of two channels.

As described above, according to the embodiment of the present disclosure, the generation unit 510 may zero-pad the DCI format for uplink scheduling such that the size of the DCI format for uplink scheduling is the same as that of the generated new DCI, or zero-pad the DCI format for sidelink scheduling such that the size of the DCI format for sidelink scheduling is the same as that of the generated new DCI. In this way, the operation of the relay process can be simplified and the delay of data transmission can be reduced without increasing the complexity of blind detection on the remote user equipment.

According to the embodiment of the present disclosure, the generation unit 510 may also generate a new DCI to include fields in a DCI format for uplink scheduling, such that a size of the DCI format for uplink scheduling is the same as that of the generated new DCI. Further, the generation unit 510 may represent the scheduling information of the first channel by using some fields in the DCI format for uplink scheduling, and represent the scheduling information of the second channel by using other fields in the DCI format for uplink scheduling.

That is, the generation unit 510 may represent the scheduling information for the second channel by reusing some fields in the DCI format for uplink scheduling. Here, necessary information that may represent the scheduling information for the second channel includes but not limited to time domain resources and frequency domain resources for the second channel. For example, the generation unit 510 may represent the fields “time gap”, “lowest index of sub-channel allocation to initial transmission”, “SCI format 0-1 field: frequency domain resource assignment” and “SCI format 0-1 field: time domain resource assignment” in DCI format 3_0 respectively by using the fields “priority indication”, “channel access-Cpext”, “minimum applicable scheduling offset indication”, and “secondary cell sleep indication” in DCI format 0_1. Of course, the above example is not restrictive, and the generation unit 510 may also reuse other fields in the DCI format for uplink scheduling.

According to the embodiment of the present disclosure, the generation unit 510 may also add a new field to indicate the reusing. For example, when the added new field indicates 1, the remote user equipment may determine that some fields in the DCI format for uplink scheduling are used to represent the scheduling information for the second channel instead of the original meaning.

According to the embodiment of the present disclosure, since the size of the DCI format for uplink scheduling is the same as that of the generated new DCI, the encoding unit 530 may scramble the generated new DCI with RNTI for uplink and downlink. In this way, the number of size of the DCI format scrambled with RNTI for uplink and downlink is still three, such that the complexity of blind detection on remote user equipment is not increased.

As described above, according to the embodiment of the present disclosure, the generation unit 510 may represent the information of the second channel by reusing some fields in the DCI format for uplink scheduling, such that the size of the DCI format for uplink scheduling is the same as that of the generated new DCI. In this way, the operation of the relay process can be simplified and the delay of data transmission can be reduced without increasing the complexity of blind detection on the remote user equipment.

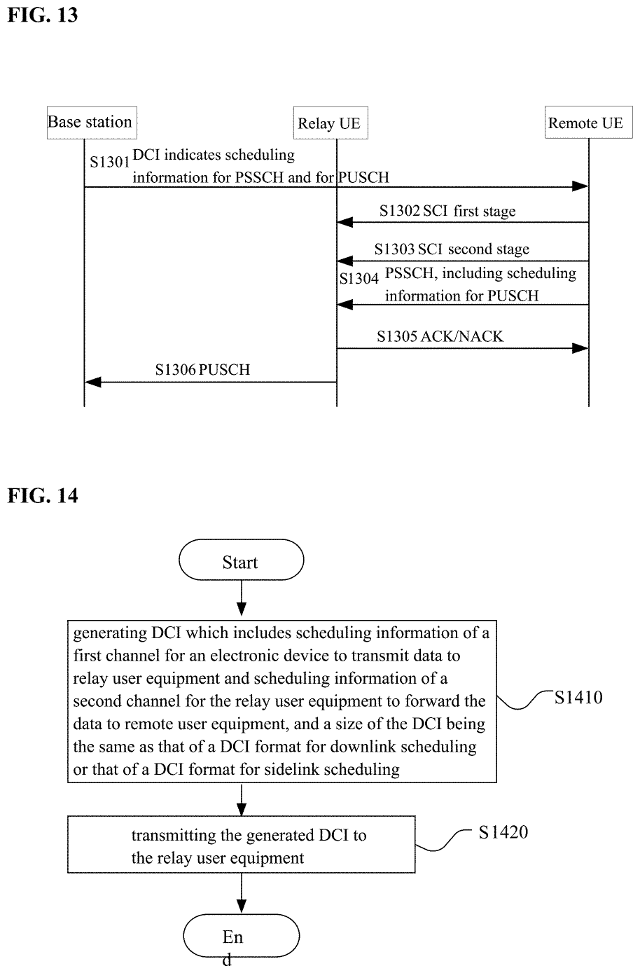

FIG. 13 is a flowchart showing signaling for performing uplink transmission by using relay UE according to an embodiment of the present disclosure. In step S1301, a base station transmits DCI to remote UE, which includes scheduling information for PSSCH and scheduling information for PUSCH. Next, in step S1302 and step S1303, the remote UE transmits SCI to relay UE in two stages. In step S1304, the remote UE transmits data to the relay UE by using PSSCH based on the scheduling information for PSSCH, which data includes scheduling information for PUSCH received from the base station. In step S1305, the relay UE transmits feedback information on PSSCH, including ACK/NACK, to the remote UE. In step S1306, the relay UE forwards data to the base station by using PUSCH based on the received scheduling information for PUSCH.

It can be seen that, according to the embodiment of the present disclosure, in uplink transmission process using the relay technology, the electronic device 500 may carry scheduling information of the first channel and the second channel by simply transmitting the DCI once, such that relay transmission process is simplified and the delay of data transmission is reduced. Further, the electronic device 500 may zero-pad the DCI format for uplink scheduling such that a size of the DCI format for uplink scheduling is the same as that of the generated new DCI, or zero-pad the DCI format for sidelink scheduling such that a size of the DCI format for sidelink scheduling is the same as that of the generated new DCI. Specifically, the electronic device 500 may also represent the information of the second channel by reusing some fields in the DCI format for uplink scheduling, such that the size of the DCI format for uplink scheduling is the same as that of the generated new DCI. In this way, the operation of the relay process can be simplified and the delay of data transmission can be reduced without increasing the complexity of blind detection on the remote user equipment.

### 5. EXAMPLE OF CONFIGURATION OF USER EQUIPMENT IN UPLINK TRANSMISSION

A configuration of an electronic device 1200 as user equipment in uplink transmission is described below, still with reference to FIG. 12. The electronic device 1200 here may be used as remote user equipment. In a wireless communication system, one user equipment may forward downlink information from a base station device to other user equipment, that is, the user equipment may serve as relay user equipment in downlink transmission. The user equipment may also transmit uplink data to the base station device via other user equipment, that is, the user equipment may serve as remote user equipment in uplink transmission. FIG. 12 in the present disclosure describes general configuration of user equipment according to the present disclosure. That is, if the user equipment serves as relay user equipment in downlink transmission, the user equipment may be configured and operated according to the aforementioned embodiments, and if the user equipment serves as remote user equipment in uplink transmission, the user equipment may be configured and operated according to the embodiments described below.

According to an embodiment of the present disclosure, the electronic device 1200 may receive DCI from the base station device via the communication unit 1210, and the DCI is used for uplink scheduling. The size of DCI is the same as that of the DCI format for uplink scheduling or the DCI format for sidelink scheduling.

According to the embodiment of the present disclosure, the determination unit 1220 may determine, based on the DCI, the scheduling information of the first channel for the electronic device 1200 to transmit data to the relay user equipment and the scheduling information of the second channel for the relay user equipment to forward data to the base station device.

According to the embodiment of the present disclosure, the first channel is PSSCH and the second channel is PUSCH.

According to the embodiment of the present disclosure, the electronic device 1200 may transmit data to the relay user equipment based on the scheduling information of the first channel. For example, the electronic device 1200 may determine time domain resources and frequency domain resources for transmitting data to the relay user equipment based on the scheduling information of the first channel. Further, the data transmitted by the electronic device 1200 to the relay user equipment may include the scheduling information of the second channel, such that the relay user equipment forwards the data to the base station device based on the scheduling information of the second channel. For example, the scheduling information of the second channel may include time domain resources and frequency domain resources for the relay user equipment to forward data to the base station device.

According to the embodiment of the present disclosure, the DCI received by the electronic device 1200 may include fields in the DCI format for uplink scheduling, and fields in the DCI format for sidelink scheduling which are not the same as those in the DCI format for uplink scheduling.

According to the embodiment of the present disclosure, the determination unit 1220 may determine the scheduling information of the first channel based on the fields in the DCI format for sidelink scheduling which are not the same as those in the DCI format for uplink scheduling, and determine the scheduling information of the second channel based on the fields in the DCI format for uplink scheduling.

According to an embodiment of the present disclosure, the decoding unit 1230 may descramble DCI with RNTI for uplink and downlink, RNTI for sidelink, or RNTI different from RNTI for uplink and downlink and RNTI for sidelink.

Further, according to the embodiment of the present disclosure, if the decoding unit 1230 successfully descrambles the DCI with RNTI for uplink and downlink, the determination unit 1220 may further determine that the DCI which is not zero-padded is a DCI including the scheduling information of two channels, while the DCI which is zero-padded is a DCI for uplink scheduling. According to the embodiment of the present disclosure, if the decoding unit 1230 successfully descrambles the DCI with RNTI for sidelink, the determination unit 1220 may further determine that the DCI which is not zero-padded is a DCI including the scheduling information of two channels, while the DCI which is zero-padded is a DCI for sidelink scheduling. If the decoding unit 1230 successfully descrambles the DCI with RNTI different from RNTI for uplink and downlink and RNTI for sidelink, the determination unit 1220 may determine that the DCI is a DCI including the scheduling information of two channels.

As described above, according to the embodiment of the present disclosure, the size of the DCI format for uplink scheduling is the same as that of the new DCI, or the size of the DCI format for sidelink scheduling is the same as that of the new DCI, such that the complexity of blind detection on the electronic device 1200 is not increased.

According to the embodiment of the present disclosure, the DCI received by the electronic device 1200 may include fields in the DCI format for uplink scheduling.

According to the embodiment of the present disclosure, the determination unit 1220 may determine the scheduling information of the first channel based on some fields in the DCI format for uplink scheduling, and determine the scheduling information of the second channel based on other fields in the DCI format for uplink scheduling.

According to the embodiment of the present disclosure, the decoding unit 1230 may descramble DCI with RNTI for uplink and downlink and RNTI for sidelink. Further, if the decoding unit 1230 successfully descrambles the DCI with RNTI for uplink and downlink, the determination unit 1220 may determine whether the DCI is a new DCI that includes scheduling information of two channels or a DCI for uplink scheduling, based on a new added field in the DCI.

For example, when the new added field in the DCI indicates 1, the determination unit 1220 may determine that some fields in the DCI format for uplink scheduling are used to represent the scheduling information for the second channel instead of the original meaning. As one example, the determination unit 1220 may represent the fields “time gap”, “lowest index of sub-channel allocation to initial transmission”, “SCI format 0-1 field: frequency domain resource assignment” and “SCI format 0-1 field: time domain resource assignment” respectively by using the fields “priority indication”, “channel access-Cpext”, “minimum applicable scheduling offset indication”, and “secondary cell sleep indication” in DCI format 0_1. That is, the determination unit 1220 may determine the scheduling information of the second channel based on the above fields. Of course, the above example is not restrictive, and other fields in the DCI format for uplink scheduling may also be reused.

As described above, according to the embodiment of the present disclosure, the size of the DCI format for uplink scheduling is the same as that of the new DCI, such that the complexity of blind detection on the electronic device 1200 is not increased.

The electronic device 500 as a network side device and the electronic device 1200 as remote user equipment are described above, that is, the electronic device 1200 may transmit uplink information to the electronic device 500 via the relay user equipment.

### 6. EMBODIMENTS OF METHODS

A wireless communication method for downlink transmission executed by the electronic device 500 as a network side device in a wireless communication system according to an embodiment of the present disclosure is described in detail below.

FIG. 14 is a flowchart showing a wireless communication method for downlink transmission executed by an electronic device 500 as a network side device in a wireless communication system according to an embodiment of the present disclosure.

As shown in FIG. 14, in step S1410, a DCI is generated, which includes scheduling information of a first channel for the electronic device 500 to transmit data to relay user equipment and scheduling information of a second channel for the relay user equipment to forward the data to remote user equipment, and a size of which is the same as that of a DCI format for downlink scheduling or that of a DCI format for sidelink scheduling

Next, in step S1420, the generated DCI is transmitted to the relay user equipment.

In an embodiment, the step of generating DCI may include making the DCI include fields in the DCI format for downlink scheduling and fields in the DCI format for sidelink scheduling which are not the same as those in the DCI format for downlink scheduling.

In an embodiment, the wireless communication method further includes zero-padding the DCI format for downlink scheduling such that the size of the DCI format for downlink scheduling is the same as that of the generated DCI, or zero-padding the DCI format for sidelink scheduling such that the size of the DCI format for sidelink scheduling is the same as that of the generated DCI.

In an embodiment, the wireless communication method further includes scrambling the generated DCI with RNTI for uplink and downlink, RNTI for sidelink, or RNTI different from the RNTI for uplink and downlink and the RNTI for sidelink.

In an embodiment, the step of generating DCI may further include making the DCI include TB indication information, which indicates that two TBs used for the relay user equipment are used for the first channel and the second channel respectively.

In an embodiment, the step of generating DCI may further include making the DCI include fields in a DCI format for downlink scheduling such that a size of the DCI format for downlink scheduling is the same as that of the generated DCI, and representing the scheduling information of the first channel with some fields in the DCI format for downlink scheduling, and representing the scheduling information of the second channel with other fields in the DCI format for downlink scheduling.

In an embodiment, the wireless communication method may further include scrambling the generated DCI with the RNTI for uplink and downlink.

In an embodiment, the wireless communication method may further include receiving, from the relay user equipment, first feedback information of the relay user equipment to the first channel and second feedback information of the remote user equipment to the second channel.

In an embodiment, the step of generating DCI may further include making the DCI include a feedback time for PSFCH. The wireless communication may further include receiving the first feedback information and the second feedback information from the relay user equipment at the feedback time for PSFCH.

In an embodiment, the step of generating DCI may further include making the DCI include a feedback time for PDSCH and a feedback time for PSFCH. The wireless communication method may further include receiving the first feedback information from the relay user equipment at the feedback time for PDSCH, and receiving the second feedback information from the relay user equipment at the feedback time for PSFCH.

In an embodiment, the first channel is PDSCH and the second channel is PSSCH.

According to embodiment of the present disclosure, the subject executing the above method may the electronic device 500 according to an embodiment of the present disclosure, and thus all of the embodiments described above with respect to the electronic device 500 are applicable thereto.

Next, a wireless communication method for downlink transmission executed by the electronic device 1200 as user equipment in a wireless communication system according to the embodiment of the present disclosure will be described in detail. Here, the user equipment may serve as relay user equipment, to forward downlink information from a base station device to remote user equipment.

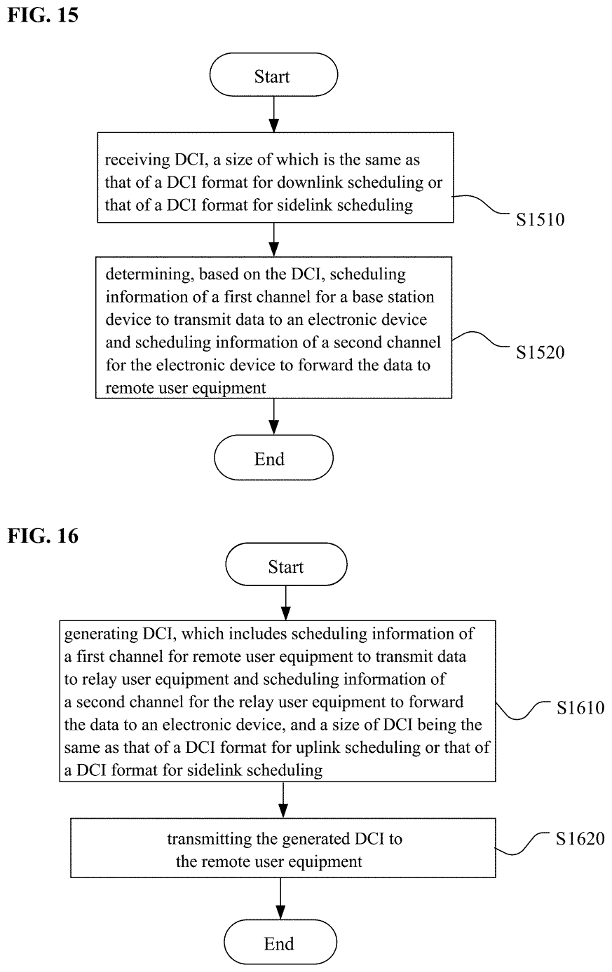

FIG. 15 is a flowchart showing a wireless communication method for downlink transmission executed by an electronic device 1200 as user equipment in a wireless communication system according to an embodiment of the present disclosure. The user equipment serves as relay user equipment.

As shown in FIG. 15, in step S1510 DCI is received, and a size of DCI is the same as that of a DCI format for downlink scheduling or a DCI format for downlink scheduling.

Next, in step S1520, scheduling information of a first channel for the base station device to transmit data to the electronic device 1200 and scheduling information of a second channel for the electronic device 1200 to forward data to the remote user equipment are determined based on the DCI.

In an embodiment, the wireless communication method may further include receiving the data from the base station device based on the scheduling information of the first channel, and forwarding the data to the remote user equipment based on the scheduling information of the second channel.

In an embodiment, the DCI includes fields in the DCI format for downlink scheduling, and fields in the DCI format for sidelink scheduling which are not the same as those in the DCI format for downlink scheduling. Besides, determining the scheduling information of the first channel may include determining the scheduling information of the first channel based on the fields in the DCI format for downlink scheduling, and determining the scheduling information of the second channel may include determining the scheduling information of the second channel based on the fields in the DCI format for sidelink scheduling which are not the same as those in the DCI format for downlink scheduling.

In an embodiment, the wireless communication method may further include descrambling the DCI with RNTI for uplink and downlink, RNTI for sidelink, or RNTI different from RNTI for uplink and downlink and RNTI for sidelink.

In an embodiment, the wireless communication method may further include determining that two TBs for the electronic device 1200 are used for the first channel and the second channel respectively based on the TB indication information included in the DCI.

In an embodiment, the DCI includes fields in the DCI format for downlink scheduling, and determining scheduling information of the first channel may include determining scheduling information of the first channel based on some fields in the DCI format for downlink scheduling, and determining scheduling information of the second channel may include determining scheduling information of the second channel based on other fields in the DCI format for downlink scheduling.

In an embodiment, the wireless communication method may further include descrambling the DCI with RNTI for uplink and downlink.

In an embodiment, the wireless communication method may further include transmitting, to the base station device, first feedback information of the electronic device 1200 to the first channel and second feedback information of the remote user equipment to the second channel.

In an embodiment, the wireless communication method may further include determining a feedback time for PSFCH based on the DCI, and transmitting the first feedback information and the second feedback information to the base station device at the feedback time for PSFCH.

In an embodiment, the wireless communication method may further include determining a feedback time for PDSCH and a feedback time for PSFCH based on the DCI, transmitting the first feedback information to the base station device at the feedback time for PDSCH, and transmitting the second feedback information to the base station device at the feedback time for PSFCH.

In an embodiment, the first channel is PDSCH and the second channel is PSSCH.

According to the embodiment of the present disclosure, the subject executing the above method may the electronic device 1200 according to an embodiment of the present disclosure, and thus all of the embodiments described above with respect to the electronic device 1200 are applicable thereto.

Next, a wireless communication method for uplink transmission executed by the electronic device 500 as a network side device in a wireless communication system according to an embodiment of the present disclosure will be described in detail.

FIG. 16 is a flowchart showing a wireless communication method for uplink transmission executed by an electronic device 500 as a network side device in a wireless communication system according to an embodiment of the present disclosure.

As shown in FIG. 16, in step S1610, DCI is generated, which includes scheduling information of a first channel for remote user equipment to transmit data to relay user equipment and scheduling information of a second channel for the relay user equipment to forward data to the electronic device 500, and a size of DCI is the same as that of a DCI format for uplink scheduling or a DCI format for sidelink scheduling.

Next, in step S1620, the generated DCI is transmitted to the remote user equipment.

In an embodiment, the step of generating DCI may include making the DCI include fields in the DCI format for uplink scheduling, and fields in the DCI format for sidelink scheduling which are not the same as those in the DCI format for uplink scheduling.

In an embodiment, the wireless communication method may further include zero-padding the DCI format for uplink scheduling such that the size of the DCI format for uplink scheduling is the same as that of the generated DCI, or zero-padding the DCI format for sidelink scheduling such that the size of the DCI format for sidelink scheduling is the same as that of the generated DCI.

In an embodiment, the wireless communication method may further include scrambling the generated DCI with RNTI for uplink and downlink, RNTI for sidelink, or RNTI different from RNTI for uplink and downlink and RNTI for sidelink.

In an embodiment, the step of generating DCI may further include making the DCI include fields in the DCI format for uplink scheduling such that the size of the DCI format for uplink scheduling is the same as that of the generated DCI, representing the scheduling information of the first channel with some fields in the DCI format for uplink scheduling, and representing the scheduling information of the second channel with other fields in the DCI format for uplink scheduling.

In an embodiment, the wireless communication method may further include scrambling the generated DCI with RNTI for uplink and downlink.

In an embodiment, the first channel is PSSCH and the second channel is PUSCH.

According to the embodiment of the present disclosure, the subject executing the above method may the electronic device 500 according to an embodiment of the present disclosure, and thus all of the embodiments described above with respect to the electronic device 500 are applicable thereto.

Next, a wireless communication method for uplink transmission executed by the electronic device 1200 as user equipment in a wireless communication system according to an embodiment of the present disclosure will be described in detail. Here, the user equipment may serve as remote user equipment, to transmit uplink information to a base station device via relay user equipment.

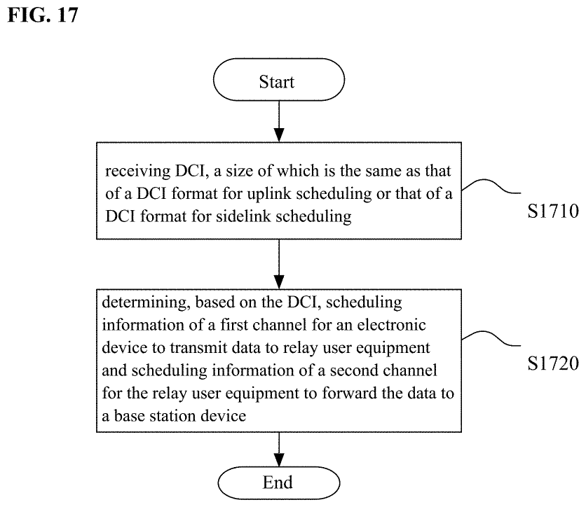

FIG. 17 is a flowchart showing a wireless communication method for uplink transmission executed by an electronic device 1200 as user equipment in a wireless communication system according to an embodiment of the present disclosure. The user equipment serves as remote user equipment.

As shown in FIG. 17, in step S1710 DCI is received, and a size of DCI is the same as that of a DCI format for uplink scheduling or a DCI format for sidelink scheduling.

Next, in step S1720, scheduling information of a first channel for the electronic device 1200 to transmit data to relay user equipment and scheduling information of a second channel for the relay user equipment to forward data to a base station device are determined based on the DCI.

In an embodiment, the wireless communication method further includes transmitting data to the relay user equipment based on the scheduling information of the first channel, which data includes the scheduling information of the second channel, such that the relay user equipment forwards the data to the base station device based on the scheduling information of the second channel.

In an embodiment, DCI includes fields in the DCI format for uplink scheduling, and fields in the DCI format for sidelink scheduling which are not the same as those in the DCI format for uplink scheduling. Besides, determining the scheduling information of the first channel may include determining the scheduling information of the first channel based on the fields in the DCI format for sidelink scheduling which are not the same as those in the DCI format for uplink scheduling, and determining the scheduling information of the second channel may include determining the scheduling information of the second channel based on the fields in the DCI format for uplink scheduling.

In an embodiment, the wireless communication method may further include descrambling the DCI with RNTI for uplink and downlink, RNTI for sidelink, or RNTI different from RNTI for uplink and downlink and RNTI for sidelink.

In an embodiment, the DCI includes fields in the DCI format for uplink scheduling. Besides, determining the scheduling information of the first channel may include determining the scheduling information of the first channel based on some fields in the DCI format for uplink scheduling, and determining the scheduling information of the second channel may include determining the scheduling information of the second channel based on other fields in the DCI format for uplink scheduling.

In an embodiment, the wireless communication method further includes descrambling the DCI with RNTI for uplink and downlink.

In an embodiment, the first channel is PSSCH and the second channel is PUSCH.

According to embodiment of the present disclosure, the subject executing the above method may the electronic device 1200 according to an embodiment of the present disclosure, and thus all of the embodiments described above with respect to the electronic device 1200 are applicable thereto.

### 7. EXAMPLES OF APPLICATION

The technology of the present disclosure may be applied to various products.

The network side device may be implemented as any type of base station device, such as a macro eNB or a small eNB, and may be implemented as any type of gNB (a base station in a 5G system). The small eNB such as a pico eNB, a micro eNB and a home (femto-cell) eNB may have a smaller coverage range than a macro cell. Alternatively, the base station may also be implemented as any other type of base stations, such as a NodeB and a base transceiver station (BTS). The base station may include a body (also referred to as a base station device) configured to control wireless communications, and one or more remote radio heads (RRH) arranged in a position separate from the body.

The user equipment may be implemented as a mobile terminal (such as smartphone, tablet personal computer (PC), notebook PC, portable game terminal, portable/dongle type mobile router, and digital camera device), or an in-vehicle terminal (such as vehicle navigation device). The user equipment may also be implemented as a terminal (that is also referred to as a machine type communication (MTC) terminal) that performs machine-to-machine (M2M) communication. In addition, the user equipment may be a wireless communication module (such as an integrated circuitry module including one wafer) mounted on each of the above user equipment.

### Examples of Application Regarding Base Station

### First Example of Application

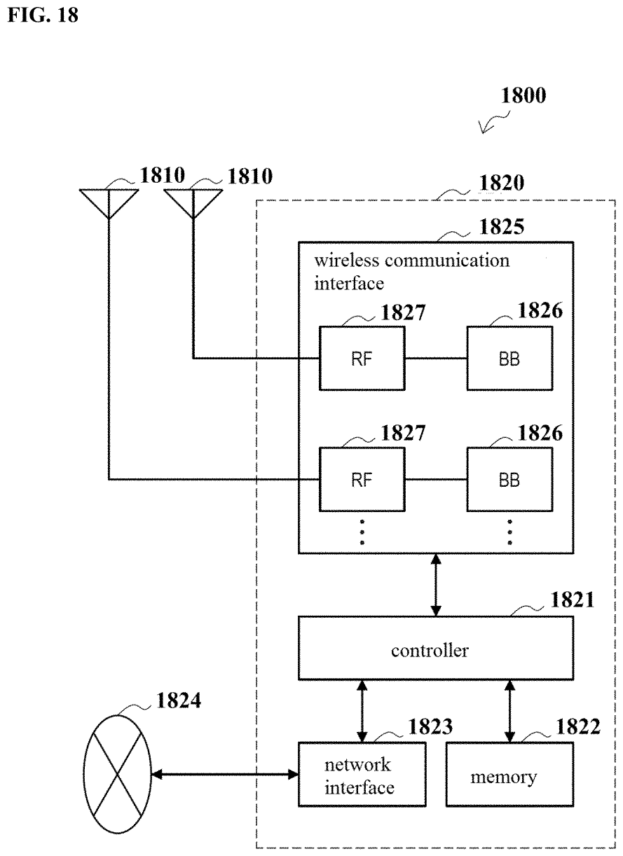

FIG. 18 is a block diagram showing a first example of a schematic configuration of an eNB to which the technique of the present disclosure may be applied. The eNB 1800 includes a single antenna or multiple antennas 1810 and a base station device 1820. The base station device 1820 and each antenna 1810 may be connected with each other via RF cable.

Each of the antennas 1810 includes one or more antenna elements (such as multiple antenna elements included in a multiple-input multiple-output (MIMO) antenna), and are used for the base station device 1820 to transmit and receive a radio signal. The eNB 1800 may include the multiple antennas 1810, as shown in FIG. 18. For example, the multiple antennas 1810 may be compatible with multiple frequency bands used by the eNB 1800. Although FIG. 18 shows an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be, for example, a CPU or a DSP, and operates various functions of a higher layer of the base station device 1820. For example, the controller 1821 generates a data packet based on data in signals processed by the wireless communication interface 1825, and transfers the generated packet via the network interface 1823. The controller 1821 may bundle data from multiple baseband processors to generate a bundled packet, and transfer the generated bundled packet. The controller 1821 may have logic functions for performing the following control: wireless resource control, wireless carrying control, mobility management, admission control and scheduling. The control may be performed in corporation with a nearby eNB or a core network node. The memory 1822 includes an RAM and an ROM, and stores a program executed by the controller 1821 and various types of control data (such as a terminal list, transmission power data and scheduling data).

The network interface 1823 is a communication interface for connecting the base station device 1820 to a core network 1824. The controller 1821 may communication with the core network node or another eNB via the network interface 1823. In this case, the eNB 1800 and the core network node or another eNB may be connected to each other via a logic interface (such as an S1 interface and an X2 interface). The network interface 1823 may be a wired communication interface or a wireless communication interface for a wireless backhaul line. If the network interface 1823 is a wireless communication interface, the network interface 1823 may use a higher frequency band for wireless communication as compared with the frequency band used by the wireless communication interface 1825.

The wireless communication interface 1825 supports any cellular communication scheme (such as Long Term Evolution (LTE) and LTE-advanced), and provides a wireless connection to a terminal located in a cell of the eNB 1800 via the antenna 1810. The wireless communication interface 1825 may generally include a baseband (BB) processor 1826 and an RF circuit 1827. The BB processor 1826 may perform for example encoding/decoding, modulation/demodulation and multiplexing/de-multiplexing, and performs various types of signal processing of layers (such as L1, Media Access Control (MAC), Radio Link Control (RLC) and Packet Data Convergence Protocol (PDCP)). Instead of the controller 1821, the BB processor 1826 may have a part or all of the above described logic functions. The BB processor 1826 may be a memory that stores a communication control program, or a module that includes a processor and a relevant circuit configured to execute the program. Update of the programs may change the function of the BB processor 1826. The module may be a card or a blade inserted into a slot of the base station device 1820. Alternatively, the module may be a chip installed on the card or the blade. In addition, the RF circuit 1827 may include for example a frequency mixer, a filter or an amplifier, and transmits and receives a radio signal via the antenna 1810.

The wireless communication interface 1825 may include multiple BB processors 1826, as shown in FIG. 18. For example, the multiple BB processors 1826 may be compatible with multiple frequency bands used by the eNB 1800. The wireless communication interface 1825 may include the multiple RF circuits 1827, as shown in FIG. 18. For example, the multiple RF circuits 1827 may be compatible with multiple antenna elements. Although FIG. 18 shows the example in which the wireless communication interface 1825 includes the multiple BB processors 1826 and the multiple RF circuits 1827, the wireless communication interface 2512 may also include a single BB processor 1826 or a single RF circuit 1827.

### Second Example of Application

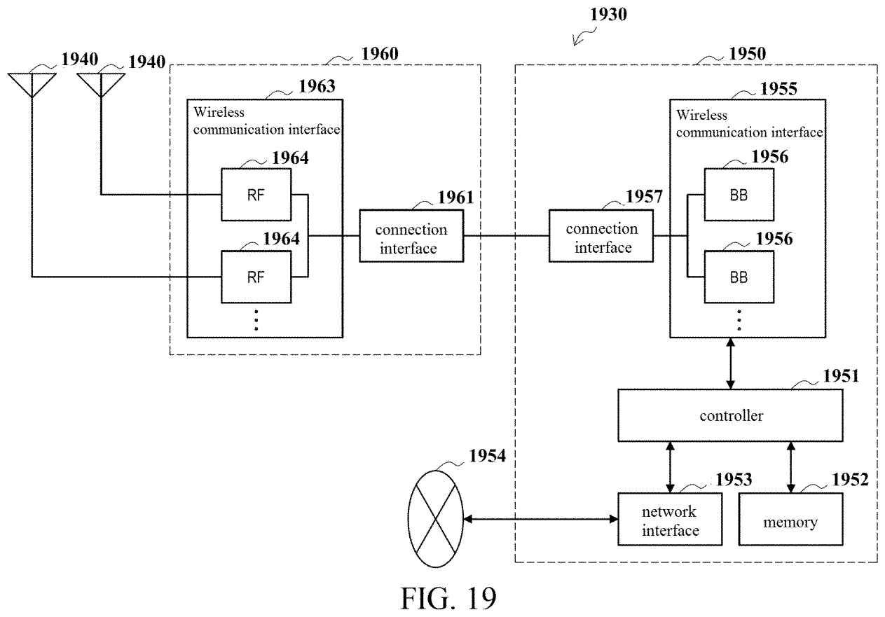

FIG. 19 is a block diagram showing a second example of an schematic configuration of an eNB to which the technology of the present disclosure may be applied. An eNB 1930 includes one or more antennas 1940, a base station device 1950 and an RRH 1960. The RRH 1960 and Each antenna 1940 may be connected to each other via an RF cable. The base station device 1950 and the RRH 1960 may be connected to each other via a high speed line such as an optical fiber cable.

Each of the antennas 1940 includes a single antenna element or multiple antenna elements (such as multiple antenna elements included in an MIMO antenna), and is used for the RRH 1960 to transmit and receive a radio signal. The eNB 1930 may include the multiple antennas 1940, as shown in FIG. 19. For example, the multiple antennas 1940 may be compatible with multiple frequency bands used by the eNB 1930. Although FIG. 19 shows an example in which the eNB 1930 includes multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 19.

The wireless communication interface 1955 supports any cellular communication scheme (such as LTE and LTE-advanced), and provides wireless communication to a terminal located in a sector corresponding to the RRH 1960 via the RRH 1960 and the antenna 1940. The wireless communication interface 1955 may generally include a BB processor 1956 for example. The BB processor 1956 is the same as the BB processor 1826 described with reference to FIG. 18, except that the BB processor 1956 is connected to the RF circuitry 1964 of the RRH 1960 via the connection interface 1957. As show in FIG. 19, the wireless communication interface 1955 may include multiple BB processors 1956. For example, the multiple BB processors 1956 may be compatible with the multiple frequency bands used by the eNB 1930. Although FIG. 19 shows an example in which the wireless communication interface 1955 includes the multiple BB processors 1956, the wireless communication interface 1955 may also include a single BB processor 1956.

The connection interface 1957 is an interface for connecting the base station device 1950 (wireless communication interface 1955) to the RRH 1960. The connection interface 1957 may also be a communication module for communication in the above described high-speed line for connecting the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for communication in the above described high-speed line.

The wireless communication interface 1963 transmits and receives a radio signal via the antenna 1940. The wireless communication interface 1963 may generally include, for example, a RF circuit 1964. The RF circuit 1964 may include, for example, a frequency mixer, a filter, and an amplifier, and transmits and receives a radio signal via the antenna 1940. The wireless communication interface 1963 may include multiple RF circuits 1964, as shown in FIG. 19. For example, the multiple RF circuits 1964 may support multiple antenna elements. Although FIG. 19 shows an example in which the wireless communication interface 1963 includes the multiple RF circuits 1964, the wireless communication interface 1963 may also include a single RF circuit 1964.

In the eNB 1800 shown in FIG. 18 and the eNB 1930 shown in FIG. 19, the generation unit 510, the encoding unit 530 and the processing unit 540 described with reference to FIG. 5 may be implemented by the controller 3231 and/or the controller 1951. At least a part of the functions may also be implemented by the controller 1821 and the controller 1951. For example, the controller 1821 and/or the controller 1951 may perform the functions of generating DCI, scrambling DCI with RNTI, and performing subsequent processing based on feedback information by executing the instructions stored in the corresponding memory.

### Examples of Application Regarding Terminal Device

### First Example of Application

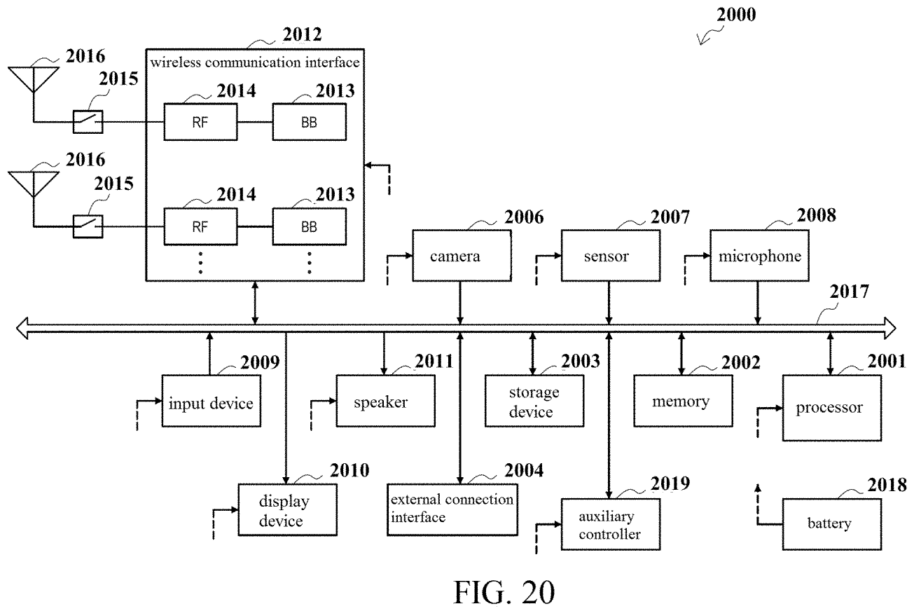

FIG. 20 is a block diagram showing an example of a schematic configuration of a smartphone 2000 to which the technology of the present disclosure may be applied. The smartphone 2000 includes a processor 2001, a memory 2002, a storage device 2003, an external connection interface 2004, a camera 2006, a sensor 2007, a microphone 2008, an input device 2009, a display device 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on a chip (SoC), and controls functions of an application layer and another layer of the smartphone 2000. The memory 2002 includes an RAM and an ROM, and stores a program that is executed by the processor 2001, and data. The storage device 2003 may include a storage medium such as a semiconductor memory and a hard disk. The external connection interface 2004 is an interface configured to connect an external device (such as a memory card and a universal serial bus (USB) device) to the smartphone 2000.

The camera 2006 includes an image sensor (such as a Charge Coupled Device (CCD) and a Complementary Metal Oxide Semiconductor (CMOS)) and generates a captured image. The sensor 2007 may include a group of sensors such as a measurement sensor, a gyro sensor, a geomagnetic sensor, and an acceleration sensor. The microphone 2008 converts sounds that are inputted to the smartphone 2000 into audio signals. The input device 2009 includes, for example, a touch sensor configured to detect touch onto a screen of the display device 2010, a keypad, a keyboard, a button, or a switch, and receive an operation or information inputted from a user. The display device 2010 includes a screen (such as a liquid crystal display (LCD) and an organic light emitting diode (OLED) display), and displays an output image of the smartphone 2000. The speaker 2011 converts audio signals that are outputted from the smartphone 2000 to sounds.

The wireless communication interface 2012 supports any cellular communication scheme (such as LTE and LTE-Advanced), and performs wireless communication. The wireless communication interface 2012 may generally include for example a BB processor 2013 and an RF circuit 2014. The BB processor 2013 may perform for example encoding/decoding, modulation/demodulation and multiplexing/de-multiplexing, and perform various types of signal processing for wireless communications. In addition, the RF circuit 2014 may include for example a frequency mixer, a filter and an amplifier, and transmit and receive a radio signal via the antenna 2016. The wireless communication interface 2012 may be one chip module on which the BB processor 2013 and the RF circuit 2014 are integrated. As shown in FIG. 20, the wireless communication interface 2012 may include multiple BB processors 2013 and multiple RF circuits 2014. Although FIG. 20 shows an example in which the wireless communication interface 2012 includes the multiple BB processors 2013 and the multiple RF circuits 2014, the wireless communication interface 2012 may also include a single BB processor 2013 or a single RF circuit 2014.

Furthermore, in addition to a cellular communication scheme, the wireless communication interface 2012 may support another type of wireless communication scheme such as a short-distance wireless communication scheme, a near field communication scheme, and a radio local area network (LAN) scheme. In this case, the wireless communication interface 2012 may include the BB processor 2013 and the RF circuit 2014 for each wireless communication scheme.

Each of the antenna switches 2015 switches connection destinations of the antennas 916 among multiple circuits (such as circuits for different wireless communication schemes) included in the wireless communication interface 2012.

Each of the antennas 2016 includes a single antenna element or multiple antenna elements (such as multiple antenna elements included in an MIMO antenna), and is used for the wireless communication interface 2012 to transmit and receive a radio signal. The smartphone 2000 may include the multiple antennas 2016, as shown in FIG. 20. Although FIG. 20 shows an example in which the smartphone 2000 includes the multiple antennas 2016, the smartphone 2000 may also include a single antenna 2016.

In addition, the smartphone 2000 may include an antenna 2016 for each wireless communication scheme. In this case, the antenna switch 2015 may be omitted from the configuration of the smartphone 2000.

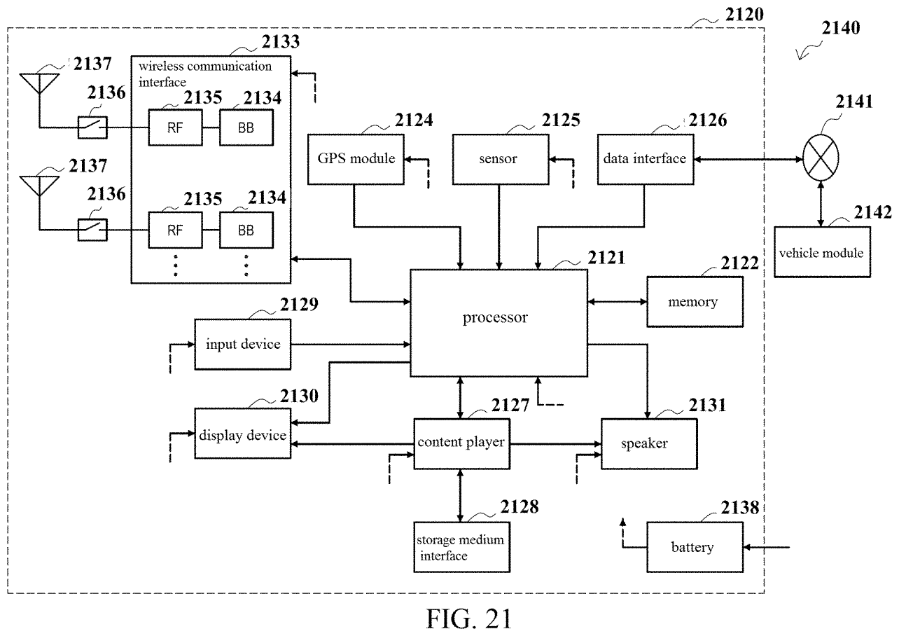

The bus 2017 connects the processor 2001, the memory 2002, the storage device 2003, the external connection interface 2004, the camera 2006, the sensor 2007, the microphone 2008, the input device 2009, the display device 2010, the speaker 2011, the wireless communication interface 2012, and the auxiliary controller 2019 to each other. The battery 2018 supplies power to blocks of the smartphone 2000 shown in FIG. 21 via feeder lines, which are partially shown as dashed lines in the figure. The auxiliary controller 2019 operates a minimum necessary function of the smartphone 2000, for example, in a sleep mode.

In the smartphone 2000 shown in FIG. 20, the determination unit 310, the storage unit 320, the request generation unit 330, the processing unit 350, the GID information generation unit 360, and the decision unit 370 described with reference to FIG. 3, and the response information generation unit 1220, the determination unit 1230, and the storage unit 1240 described with reference to FIG. 12 may be implemented by the processor 2001 or the auxiliary controller 2011. At least a part of the functions may be implemented by the processor 2001 and the auxiliary controller 2019. For example, The processor 2001 or the auxiliary controller 2019 may perform the following functions by executing the instructions stored in the memory 2002 or the storage device 2003: determining scheduling information of a first channel for a base station device to transmit data to a vehicle navigation device 2120 and scheduling information of a second channel for the smartphone 2000 to forward data to remote user equipment; determining scheduling information of a first channel for the smartphone 2000 to transmit data to relay user equipment and scheduling information of a second channel for the relay user equipment to forward data to the base station device; descrambling DCI with RNTI; and generating feedback information.

### Second Example of Application

FIG. 21 is a block diagram showing an example of a schematic configuration of a vehicle navigation device 2120 to which the technology of the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a wireless communication interface 2133, one or more antenna switches 2136, one or more antennas 2137, and a battery 2138.

The processor 2121 may be for example a CPU or a SoC, and controls a navigation function and another functions of the vehicle navigation device 2120. The memory 2122 includes an RAM and an ROM, and stores a program that is executed by the processor 2121, and data.

The GPS module 2124 determines a position (such as latitude, longitude, and altitude) of the vehicle navigation device 2120 by using GPS signals received from a GPS satellite. The sensor 2125 may include a group of sensors, such as a gyro sensor, a geomagnetic sensor, and an air pressure sensor. The data interface 2126 is connected to, for example, an in-vehicle network 2141 via a terminal that is not shown, and acquires data generated by the vehicle (such as vehicle speed data).

The content player 2127 reproduces content stored in a storage medium (such as a CD and a DVD) inserted into the storage medium interface 2128. The input device 2129 includes, for example, a touch sensor configured to detect touch on a screen of the display device 2130, a button, or a switch, and receives an operation or information inputted by a user. The display device 2130 includes a screen such as a LCD or an OLED display, and displays an image of the navigation function or content that is reproduced. The speaker 2131 outputs sounds of the navigation function or the content that is reproduced.

The wireless communication interface 2133 supports any cellular communication scheme (such as LTE and LTE-advanced) and performs wireless communication. The wireless communication interface 2133 may generally include, for example, a BB processor 2134 and an RF circuit 2135. The BB processor 2134 may perform for example encoding/decoding, modulation/demodulation and multiplexing/de-multiplexing, and perform various types of signal processing for wireless communications. In addition, the RF circuit 2135 may include a frequency mixer, a filter and an amplifier for example, and transmits and receives a radio signal via the antenna 2137. The wireless communication interface 2133 may be a chip module on which the BB processor 2134 and the RF circuit 2135 are integrated. The wireless communication interface 2133 may include multiple BB processors 2134 and multiple RF circuits 2135, as shown in FIG. 21. Although FIG. 21 shows an example in which the wireless communication interface 2133 includes the multiple BB processors 2134 and the multiple RF circuits 2135, the wireless communication interface 2512 may also include a single BB processor 2134 or a single RF circuit 2135.

Furthermore, in addition to a cellular communication scheme, the wireless communication interface 2133 may support another type of wireless communication scheme such as a short-distance wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches connection destinations of the antenna 2137 among multiple circuits (such as circuits for different wireless communication schemes) included in the wireless communication interface 2133.

Each of the antennas 2137 includes single antenna element and multiple antenna elements (such as multiple antenna elements included in the MIMO antenna), and is used for the wireless communication interface 203 to transmit and receive a radio signal. As shown in FIG. 21, the vehicle navigation device 2120 may include multiple antennas 2137. Although FIG. 21 shows an example in which the vehicle navigation device 2120 includes multiple antennas 2137, the vehicle navigation device 2120 may also include a single antenna 2137.

In addition, the vehicle navigation device 2120 may include an antenna 2137 for each wireless communication scheme. In this case, the antenna switches 2136 may be omitted from the configuration of the vehicle navigation device 2120.

The battery 2138 supplies power to the modules of the vehicle navigation device 2120 shown in FIG. 21 via feeder lines, which are partially shown as dashed lines in the figure. The battery 2138 accumulates power provided by the vehicle.

In the vehicle navigation device 2120 shown in FIG. 21, the determination unit 1220, the decoding unit 1230 and the feedback unit 1240 described with reference to FIG. 12 may be implemented by the processor 2121. At least a portion of the functions may be implemented by the processor 2121. For example, The processor 2121 may perform the following functions by executing the instructions stored in the memory 2122: determining scheduling information of a first channel for a base station device to transmit data to a vehicle navigation device 2120 and scheduling information of a second channel for the vehicle navigation device 2120 to forward data to remote user equipment; determining scheduling information of a first channel for the vehicle navigation device 2120 to transmit data to relay user equipment and scheduling information of a second channel for the relay user equipment to forward data to the base station device; descrambling DCI with RNTI; and generating feedback information.

The technology of the present disclosure may also be implemented as an in-vehicle system (or a vehicle) 2140 including one or more of blocks of the vehicle navigation device 2120, the in-vehicle network 2141 and a vehicle module 2142. The vehicle module 2142 generates vehicle data (such as a vehicle speed, an engine speed, and trouble information), and outputs the generated data to the in-vehicle network 2141.

Preferred embodiments of the present disclosure have been described above with reference to the drawings, but the present disclosure is not limited to the above examples of course. Those skilled in the art may make various changes and modifications within the scope of the appended claims, and it should be understood that such changes and modifications naturally fall within the technical scope of the present disclosure.

For example, units shown by a dotted line block in the functional block diagram shown in the drawings indicate that the functional units are optional in the corresponding devices, and the optional functional units may be combined appropriately to achieve required functions.

For example, multiple functions implemented by one unit in the above embodiments may be implemented by separate devices. Alternatively, multiple functions implemented by multiple units in the above embodiments may be implemented by separate devices, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in other order appropriately.

Embodiments of the present disclosure are described in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic device, comprising processing circuitry configured to:
generate downlink control information DCI, which comprises scheduling information of a first channel for the electronic device to transmit data to relay user equipment and scheduling information of a second channel for the relay user equipment to forward the data to remote user equipment, and a size of which is the same as that of a DCI format for downlink scheduling or that of a DCI format for sidelink scheduling; and
transmit the generated DCI to the relay user equipment.

2. The electronic device according to claim 1, wherein the processing circuitry is further configured to:
generate the DCI to comprise: fields in the DCI format for downlink scheduling and fields in the DCI format for sidelink scheduling which are not the same as those in the DCI format for downlink scheduling; and
generate the DCI to comprise transport block TB indication information, which indicates that two TBs used for the relay user equipment are used for the first channel and the second channel respectively.

3. The electronic device according to claim 2, wherein the processing circuitry is further configured to:
zero-pad the DCI format for downlink scheduling such that the size of the DCI format for downlink scheduling is the same as that of the generated DCI; or
zero-pad the DCI format for sidelink scheduling such that the size of the DCI format for sidelink scheduling is the same as that of the generated DCI.

4. The electronic device according to claim 3, wherein the processing circuitry is further configured to:
scramble the generated DCI with RNTI for uplink and downlink, RNTI for sidelink, or RNTI different from the RNTI for uplink and downlink and the RNTI for sidelink.

5. (canceled)

6. The electronic device according to claim 1, wherein the processing circuitry is further configured to:
generate the DCI to comprise fields in a DCI format for downlink scheduling such that a size of the DCI format for downlink scheduling is the same as that of the generated DCI;
represent the scheduling information of the first channel with some fields in the DCI format for downlink scheduling, and represent the scheduling information of the second channel with other fields in the DCI format for downlink scheduling; and
scramble the generated DCI with the RNTI for uplink and downlink.

7. (canceled)

8. The electronic device according to claim 1, wherein the processing circuitry is further configured to:
generate the DCI to comprise a feedback time for a physical sidelink feedback channel PSFCH; and
receive, from the relay user equipment, first feedback information of the relay user equipment to the first channel and second feedback information of the remote user equipment to the second channel at the feedback time for PSFCH.

9. (canceled)

10. The electronic device according to claim 8, wherein the processing circuitry is further configured to:
generate the DCI to comprise a feedback time for a physical downlink shared channel PDSCH and a feedback time for a physical sidelink feedback channel PSFCH;
receive the first feedback information from the relay user equipment at the feedback time for PDSCH; and
receive the second feedback information from the relay user equipment at the feedback time for PSFCH.

11. The electronic device according to claim 8, wherein the first channel is a physical downlink shared channel PDSCH and the second channel is a physical sidelink shared channel PSSCH.

12. An electronic device, comprising processing circuitry configured to:
receive downlink control information DCI, wherein a size of the DCI is the same as that of a DCI format for downlink scheduling or that of a DCI format for sidelink scheduling; and
determine, based on the DCI, scheduling information of a first channel for a base station device to transmit data to the electronic device and scheduling information of a second channel for the electronic device to forward the data to remote user equipment.

13. The electronic device according to claim 12, wherein the processing circuitry is further configured to:
receive the data from the base station device based on the scheduling information of the first channel; and
forward the data to the remote user equipment based on the scheduling information of the second channel.

14. The electronic device according to claim 12, wherein the DCI comprises fields in the DCI format for downlink scheduling and fields in the DCI format for sidelink scheduling which are not the same as those in the DCI format for downlink scheduling,
the processing circuitry is further configured to: determine the scheduling information of the first channel based on the fields in the DCI format for downlink scheduling; and determine the scheduling information of the second channel based on the fields in the DCI format for sidelink scheduling which are not the same as those in the DCI format for downlink scheduling, and
the processing circuitry is further configured to descramble the DCI with RNTI for uplink and downlink, RNTI for sidelink, or RNTI different from the RNTI for uplink and downlink and the RNTI for sidelink link.

15. (canceled)

16. The electronic device according to claim 14, wherein the processing circuitry is further configured to:
determine that two TBs used for the electronic device are used for the first channel and the second channel respectively, based on transport block TB indication information comprised in the DCI.

17. The electronic device according to claim 12, wherein the DCI comprises fields in the DCI format for downlink scheduling,
the processing circuitry is further configured to: determine the scheduling information of the first channel based on some fields in the DCI format for downlink scheduling; and determine the scheduling information of the second channel based on other fields in the DCI format for downlink scheduling, and
the processing circuitry is further configured to descramble the DCI with the RNTI for uplink and downlink.

18. (canceled)

19. The electronic device according to claim 12, wherein the processing circuitry is further configured to:
determine a feedback time for a physical sidelink feedback channel PSFCH based on the DCI; and
transmit, to the base station device, first feedback information of the electronic device to the first channel and second feedback information of the remote user equipment to the second channel at the feedback time for PSFCH.

20. (canceled)

21. The electronic device according to claim 19, wherein the processing circuitry is further configured to:
determine, based on the DCI, a feedback time for a physical downlink shared channel PDSCH and a feedback time for a physical sidelink feedback channel PSFCH;
transmit the first feedback information to the base station device at the feedback time for PDSCH; and
transmit the second feedback information to the base station device at the feedback time for PSFCH.

22. (canceled)

23. An electronic device, comprising processing circuitry configured to:
generate downlink control information DCI, which comprises scheduling information of a first channel for remote user equipment to transmit data to relay user equipment and scheduling information of a second channel for the relay user equipment to forward the data to the electronic device, and a size of which is the same as that of a DCI format for uplink scheduling or that of a DCI format for sidelink scheduling; and
transmit the generated DCI to the remote user equipment.

24. The electronic device according to claim 23, wherein the processing circuitry is further configured to:
generate the DCI to comprise: fields in the DCI format for uplink scheduling and fields in the DCI format for sidelink scheduling which are not the same as those in the DCI format for uplink scheduling.

25. The electronic device according to claim 24, wherein the processing circuitry is further configured to:
zero-pad the DCI format for uplink scheduling such that the size of the DCI format for uplink scheduling is the same as that of the generated DCI; or
zero-pad the DCI format for sidelink scheduling such that the size of the DCI format for sidelink scheduling is the same as that of the generated DCI.

26. The electronic device according to claim 24, wherein the processing circuitry is further configured to:
scramble the generated DCI with RNTI for uplink and downlink, RNTI for sidelink, or RNTI different from the RNTI for uplink and downlink and the RNTI for sidelink link.

27. The electronic device according to claim 23, wherein the processing circuitry is further configured to:
generate the DCI to comprise fields in a DCI format for uplink scheduling such that a size of the DCI format for uplink scheduling is the same as that of the generated DCI;
represent the scheduling information of the first channel with some fields in the DCI format for uplink scheduling, and represent the scheduling information of the second channel with other fields in the DCI format for uplink scheduling; and
scramble the generated DCI with the RNTI for uplink and downlink.

28.-41. (canceled)
